(19) United States
(12) Patent Application Publication
(10) Pub. No.: US 2025/0047342 A1
(43) Pub. Date: Feb. 6, 2025

(54) UPLINK INTERFERENCE REJECTION COMBINING (IRC) SPLIT IN LOWER-LAYER SPLIT

(71) Applicant: Telefonaktiebolaget LM Ericsson (publ), Stockholm (SE)

(72) Inventors: Yezi HUANG, Täby (SE); Chenguang LU, Sollentuna (SE); Miguel BERG, Sollentuna (SE)

(21) Appl. No.: 18/696,551

(22) PCT Filed: Aug. 30, 2022
(86) PCT No.: PCT/EP2022/074045

§ 371 Date: Mar. 28, 2024

Related U.S. Application Data
(60) Provisional application No. 63/253,304, filed on Oct. 7, 2021.

(51) Int. Cl. H04B 7/06; H04B 7/022; H04B 7/0413

(52) U.S. Cl. CPC H04B 7/0617; H04B 7/022; H04B 7/0413

(57) ABSTRACT

A method by a RU node for performing frequency-domain beamforming for communication between a base station (BS) and UEs in a network using a multiple antenna system, the BS including a DU node connected to the RU node, the method including: obtaining uplink signals including K user-layer signals overlaid with interference signals and noise as received at N antennas from a number of UEs; determining: a channel estimation matrix H of wireless communication channels between a number of UEs and N antennas; an estimate of an Interference plus Noise covariance matrix Q based on H and other channel information; a first part beamforming weights, BFWs; an effective channel matrix H_{eff} based on H and the first part BFWs; and intermediate uplink signals having K components and based on the uplink signals and the first part BFWs; and sending H_{eff} and the intermediate uplink signals towards the DU node.

### TECHNICAL FIELD

The present disclosure relates generally to communications, and more particularly to communication methods and related devices and nodes supporting wireless communications.

### BACKGROUND

Massive multiple-input multiple output (MIMO) have been first adopted to practice in long term evolution (LTE). In 5th generation (5G), massive MIMO becomes one key technology component, which will be deployed in a much larger scale than in LTE. Features include a large number of antennas used on the base-station side, where the number of antennas is typically much larger than the number of user-layers, for example, 64 antennas serving 8 or 16 user-layers in frequency range 1 (FR1), which comprises sub-6 GHz frequency bands, and 256/512 antennas serving 2 or 4 layers in frequency range 2 (FR2), which comprises frequency bands from 24.25 GHz to 52.6 GHz. A user layer when used herein e.g., means an independent downlink or uplink data stream intended for one user. One user or UE may have one or multiple user layers. User layers is often denoted as layers for simplicity reason. Massive MIMO is also referred to as massive beamforming, which forms narrow beams focusing on different directions to counteract against an increased path loss at higher frequency bands. It also benefits multi-user MIMO which allows for transmissions from/to multiple users simultaneously over separate spatial channels resolved by the massive MIMO technologies, while keeping high capacity for each user. Therefore, it can significantly increase the spectrum efficiency and cell capacity.

At the base-station side, the interface between the baseband unit (BBU) and the radio unit (RU) is the fronthaul interface, whereas the interface between the BBU and the core network (CN) is the backhaul interface. The great benefits of massive MIMO at the air-interface also introduce new challenges at the base-station side. The legacy CPRI-type (common public radio interface-type) fronthaul transports time-domain IQ samples per antenna branch. As the number of antennas scales up in massive MIMO systems, the required fronthaul capacity also increases proportionally, which significantly drives up the fronthaul costs. To address this challenge, the fronthaul interface evolved from CPRI to enhanced CPRI (eCPRI), a packet-based fronthaul interface. In eCPRI, other functional split options than transporting time-domain IQ samples between a BBU and a RU are supported, referred to as different lower-layer split (LLS) options. The basic idea is to move the frequency-domain beamforming function from BBU to RU so that frequency-domain samples or data of user-layers are transported over the fronthaul interface. Note that the frequency-domain beamforming is sometimes also referred to as precoding in the downlink (DL) direction and equalizing or pre-equalizing in uplink (UL) direction. By doing this, the required fronthaul capacity and thereby the fronthaul costs are significantly reduced, as the number of user layers is typically much fewer than the number of antennas in massive MIMO.

### SUMMARY

In the uplink MIMO systems, the minimum mean square error-interference rejection combining (MMSE-IRC) method mitigates both intra-cell interferences and co-channel interferences originating from other cells. However, the interference rejection combining (IRC) coefficients for an N-antenna base station requires calculating an N×N matrix inversion plus other N-dimensional matrix multiplications per subcarrier or per subcarrier group (SCG) comprising multiple subcarriers per group. Thus, it would be beneficial to distribute the IRC processing between RU and DU, instead of having all IRC processing in RU. Meanwhile, the processing in the RU is supposed to reduce the number of UL data streams to be much less than N to improve the fronthaul efficiency. Split of the IRC processing between RU and DU may also benefit when multiple RUs are connected to one DU where the signals from multiple RUs can be jointly processed in the DU to further enhance the performance.

Prior solutions to an IRC split method was introduced by remodeling the classical IRC formulation to be a zero-forcing (ZF) process of an “extended” channel and decomposing the ZF processing into two parts, which were calculated and implemented in RU and DU, respectively. In this method, the number of dominating interferers, denoted as J, needs to be estimated. If the number of user layers are denoted as K, then the number of UL data streams can be reduced from N to K+J after the part of processing allocated in the RU. However, it is still desired to reduce the number of UL data streams directly to K.

In various embodiments of inventive concepts, an IRC split method is provided which distributes the computational complexity for IRC between RU and DU while reducing the number of UL data streams to be the number of user layers. According to the invention, RU calculates the first part BFWs W₁ based on the UL channel estimates H and covariance matrix of interference and noise Q. After conducting the first part beamforming using W₁, the number of UL data streams is reduced from the number of antennas N to the number of user layers K, and the effective UL channel becomes H_{eff}=W₁H. At the DU side, the DU either receives information of H_{eff} from the RU or the DU estimates H_{eff}. Then the second part BFWs W₂ is calculated based on H_{eff}. The combination of W₁ and W₂ is equivalent to implementing an IRC receiver.

According to some embodiments, a method performed by a radio unit, RU, node of a base station system for performing frequency-domain beamforming for a communication between a base station and a plurality of User Equipments, UEs, in a wireless communications network adapted to use a multiple antenna system for communication is provided, where the base station system further includes a distributed unit, DU, node connected to the RU node over a fronthaul interface, the RU node being connected to N antennas. The method includes obtaining uplink signals as received at N antennas from a number of UEs, wirelessly connected to the RU node, the N uplink signals comprising K user-layer signals overlaid with interference signals and noise. The method includes determining a channel estimation matrix H of wireless communication channels between a number of UEs and N antennas from reference signals as received at the N antennas from the number of UEs. The method includes determining an estimate of an Interference plus Noise, IpN, covariance matrix Q based on the channel estimation matrix H and on other channel information different from the channel estimation matrix. The method includes determining a first part beamforming weights, BFWs, of a beamforming matrix W₁, wherein W₁=H^{H}Q⁻¹ where H^{H} is a Hermitian transpose (also referred to as a conjugate transpose) of H. The method includes determining an effective channel matrix H_{eff} based on the channel estimation matrix H and the first part BFWs of the beamforming matrix W₁. The method includes determining intermediate uplink signals based on the uplink signals and the first part BFWs of the beamforming matrix W₁, the intermediate signals having K components. The method includes sending the effective channel matrix H_{eff} and the intermediate uplink signals towards the DU node over the fronthaul interface.

Analogous radio unit nodes, computer programs, and computer program products are provided.

An advantage that may be achieved by the two-phase operation in RU and DU is that the two-phase operation is equivalent to implementing an IRC receiver. Achieving high performance at the air interface is enabled with reduced computational complexity at the RU, and the fronthaul load for UL data stream may be reduced from the number of antennas to the number of user-layers. Furthermore, when multiple RUs are connected to one DU, the signals from multiple RUs can be jointly processed in the DU to further enhance the performance.

According to other embodiments, a method performed by a distributed unit, DU, node for assisting a radio unit, RU, node to perform beamforming for a communication between a base station and a user equipment, UE, in a wireless communications network using a multiple antenna system for communication is provided, wherein the DU node and the RU node are associated with the base station. The method includes receiving, from the RU node over a fronthaul interface, intermediate uplink signals. The method includes obtaining an effective channel matrix H_{eff}. The method includes determining a second part Beamforming Weights, BFWs, of a beamforming matrix W₂=(H_{eff}+σ²I)⁻¹ based on the effective channel matrix H_{eff} and a regularization factor σ². The method includes determining output signals, which are estimations of K user-layer signals, by multiplying the intermediate uplink signals sent by the RU node with the second part BFWs of the beamforming matrix W₂.

Analogous distributed unit (DU) nodes, computer programs, and computer program products are provided.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an example of an operating environment according to some embodiments;

FIG. 2 is a block diagram illustrating a wireless device UE according to some embodiments of inventive concepts;

FIG. 3 is a block diagram illustrating a radio unit node according to some embodiments of inventive concepts;

FIG. 4 is a block diagram illustrating a distributed unit node according to some embodiments of inventive concepts;

FIG. 5 is a block diagram illustrating a radio unit determining an effective channel matrix H_{eff} and providing the determined effective channel matrix H_{eff} to a distributed unit according to some embodiments of inventive concepts;

FIG. 6 is a block diagram illustrating a determined effective channel matrix H_{eff} being compressed by a radio unit according to some embodiments of inventive concepts;

FIG. 7 is a block diagram illustrating a plurality of radio units determining an effective channel matrix H_{eff} and providing the determined effective channel matrix H_{eff} to a distributed unit according to some embodiments of inventive concepts

FIG. 8 is a block diagram illustrating a distributed unit estimating an effective channel matrix H_{eff} according to some embodiments of inventive concepts;

FIG. 9 is a block illustrating a distributed unit estimating an effective channel matrix H_{eff} based on a plurality of radio units according to some embodiments of inventive concepts;

FIGS. 10-12 are flow charts illustrating operations of a radio unit according to some embodiments of inventive concepts;

FIGS. 13-18 are flow charts illustrating operations of a distributed unit according to some embodiments of inventive concepts;

FIG. 19 is a block diagram of a communication system in accordance with some embodiments;

FIG. 20 is a block diagram of a user equipment in accordance with some embodiments

FIG. 21 is a block diagram of a network node in accordance with some embodiments;

FIG. 22 is a block diagram of a host computer communicating with a user equipment in accordance with some embodiments;

FIG. 23 is a block diagram of a virtualization environment in accordance with some embodiments; and

FIG. 24 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, various embodiments of an IRC split method are provided which distribute the computational complexity for IRC between RU and DU while reducing the number of UL data streams to be the number of user layers.

A “RU” when used herein e.g., is a network node comprising of radio functions including a portion of PHY functions according to an LLS option. The RU performs conversion between radio frequency (RF) signals and baseband signals. At the network end, it transmits and receives the frequency-domain IQ data (modulated user data) or unmodulated user data to and from BBU through a fronthaul interface (e.g., eCPRI). At the other end, it transmits and receives the RF signals to and from UEs through its antennas.

A “BBU” when used herein e.g., is a network node performing baseband processing. It can be composed by a central unit (CU) and distributed unit (DU) connected via F1 interface when a higher layer split is used. Note that BBU and RU are referred to as O-DU and O-RU, respectively, in O-RAN (See Control, User and Synchronization Plane Specification, O-RAN.WG4.CUS.0-V06.00).

In some terminologies, RU can be also referred to as RRU (remote radio unit) and BBU can also be referred to as a digital unit or distributed unit (DU). In eCPRI terminologies, BBU and RU are referred to as eREC (eCPRI Radio Equipment Control) and eRE (eCPRI Radio Equipment), respectively. In another terminology, BBU and RU may be referred to as LLS-CU and LLS-DU, respectively. The DU and its equivalence can also be softwarized or virtualized as Baseband Processing Function in a Cloud environment. In the following, a general term of DU and RU is used, but use of those terms herein are not intended to limit the application of the innovation, which can be used in any suitable communication field.

A “beam” when used herein e.g., means a directional beam formed by multiplying a signal with different weights, in frequency-domain, at multiple antennas such that the energy of the signal is concentrated from/to a certain direction, or concentrated in a volume in space.

“Beamforming” when used herein e.g., means a technique which multiplies a signal with different weights (in frequency-domain, e.g., a weight is a complex number used per subcarrier for performing beamforming) at multiple antennas, which enables the signal energy to be received or sent in space with a desired beam pattern, e.g., by forming a directional beam concentrating on certain direction (or in a certain volume in space) or forming nulling in certain directions (or in certain volumes in space), or a combination of both.

The wording “beamforming weights” when used herein e.g., means sets of complex weights, each set of complex weights is multiplied with a signal of one user-layer at a subcarrier or a group of subcarriers. The weighted signals of different user layers towards the same antenna or transmit beam are combined linearly. As a result, different user-layer signals are beamformed to different directions.

A “desired cell/channel” when used herein may mean the cell/channel which connects to the UEs of the K user-layers.

“User-plane data” when used herein e.g., means the frequency-domain user-layer data sent over fronthaul.

The wording “beamforming performance” when used herein may mean signal quality in UL at the base station side after the beamforming has been performed at the base-station side, measured by, for example, post-processing signal-to-interference-and-noise-power ratio (SINR), resulted user throughput, bit rate, etc.

The wording “channel information”, when used herein, e.g., means the information about channel properties carried by the channel values. The wording channel value, also referred to as channel data, when used herein e.g., means one or a set of complex values representing the amplitude and phase of the channel coefficients in frequency domain. The channel values are related to the frequency response of the wireless channel. The channel values are usually determined by certain channel estimation algorithms based on the received signals. Channel estimates represent the estimates of the channel values obtained from channel estimation algorithms.

The wording “antenna space” when used herein e.g., means the corresponding referred data quantity such as signal, channel, BFW etc. is associated with each of the antenna elements at the RU. The concept of an antenna element is non-limiting in the sense that it can refer to any virtualization (e.g., linear mapping) of a transmitted signal to the physical antenna elements. For example, groups of physical antenna elements could in case of a DL transmission be fed the same signal, and hence they share the same virtualized antenna port when observed at the receiver. Hence, the receiver cannot distinguish and measure the channel from each individual antenna element within the group of element that are virtualized together. In a similar manner the concept of an antenna element is non-limiting also when related to an UL reception; here any virtualization can be applied to the physical antenna elements to generate one received signal corresponding to an antenna element.

The wording “beam space” when used herein e.g., means the corresponding referred quantity such as signal, channel, BFW etc. is associated with each of some predefined beams. For example, a set of signals, received or transmitted, corresponding to a set of antenna elements can be transformed to the beam space by applying a virtualization (e.g., linear mapping) to the set of signals. This virtualization produces a second set of signals and these signals are in the beam space. Depending on the design of the virtualization the second set of signals may correspond to one beam or multiple beams. The properties of these beams will in turn depend on the virtualization.

The wording “user layer” can refer to an independent downlink (“DL”) or uplink (“UL”) data stream intended for one user. One user or communication devices (also referred to herein as a user equipment (“UE”)) may have one or multiple user layers. Massive MIMO can also be referred to as massive beamforming, which is able to form narrow beams focusing on different directions to counteract against the increased path loss at higher frequency bands. It also benefits multi-user MIMO which allows for transmissions from/to multiple users simultaneously over separate spatial channels resolved by the massive MIMO technologies, while keeping high capacity for each user. Therefore, it can significantly increase the spectrum efficiency and cell capacity.

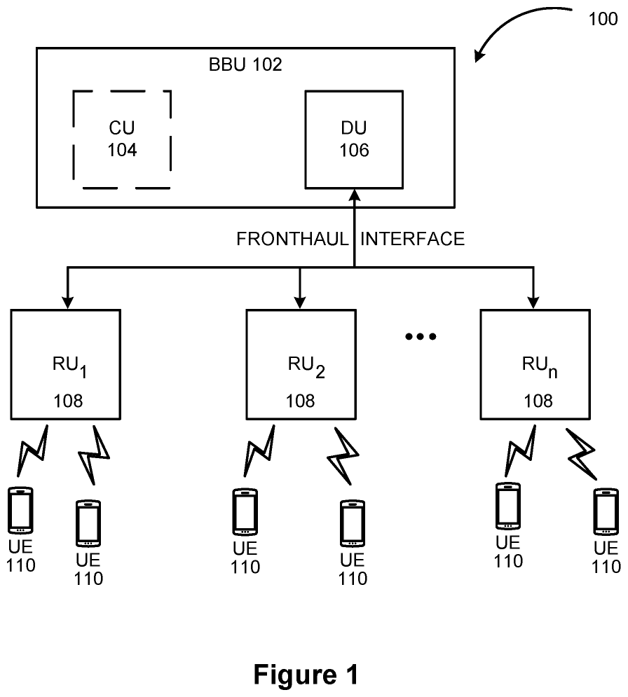

FIG. 1 illustrates an example of an operating environment 100 in which the various embodiments of inventive concepts can be implemented. In FIG. 1, the baseband unit (BBU) 102 is a network node performing baseband processing. It can be composed by a central unit (CU) 104 and distributed unit (DU) 106 connected via F1 interface (not shown) when a higher layer split is used. The CU 104 and DU 106, while shown as components of BBU 102, each may be a stand-alone component (e.g., a node) and their equivalence can also be softwarized or virtualized as Baseband Processing Function in a Cloud environment.

The DU 106 communicates with radio units (RUs) 108 over a fronthaul interface and there can be any number of RUs. Note that a fronthaul interface may comprise multiple communication ports, e.g., Ethernet ports and some RUs can be connected to different fronthaul interface ports on the DU. FIG. 1 illustrates n RUs. The fronthaul interface may be a wired interface, a wireless interface, or a combination of a wired interface and a wireless interface.

The RU 108 is a network node comprising of radio functions including a portion of PHY functions according to an LLS option. The RU 108 performs conversion between radio frequency (RF) signals and baseband signals. At the network end, the RU 108 transmits and receives the frequency-domain IQ data (modulated user data) or unmodulated user data to and from BBU 102 through a fronthaul interface (e.g., eCPRI). At the other end, the RU 108 transmits and receives the RF signals to and from UEs 110 through the RU's antennas.

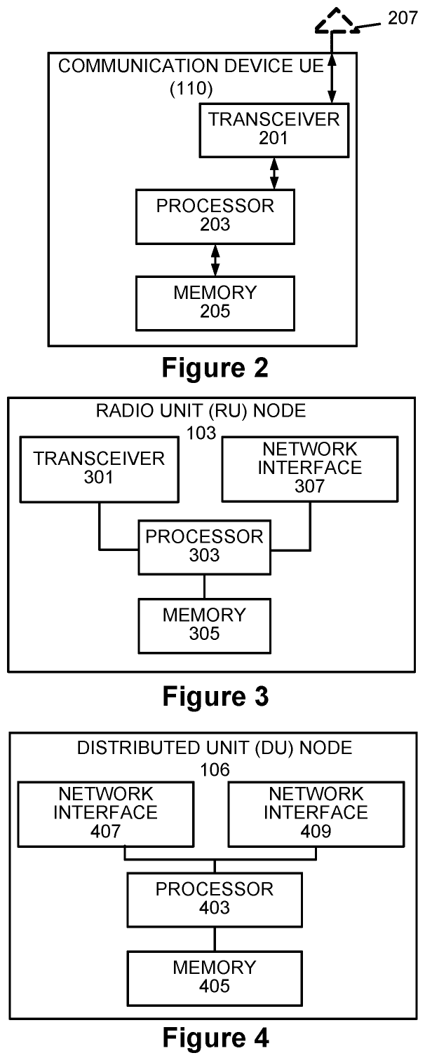

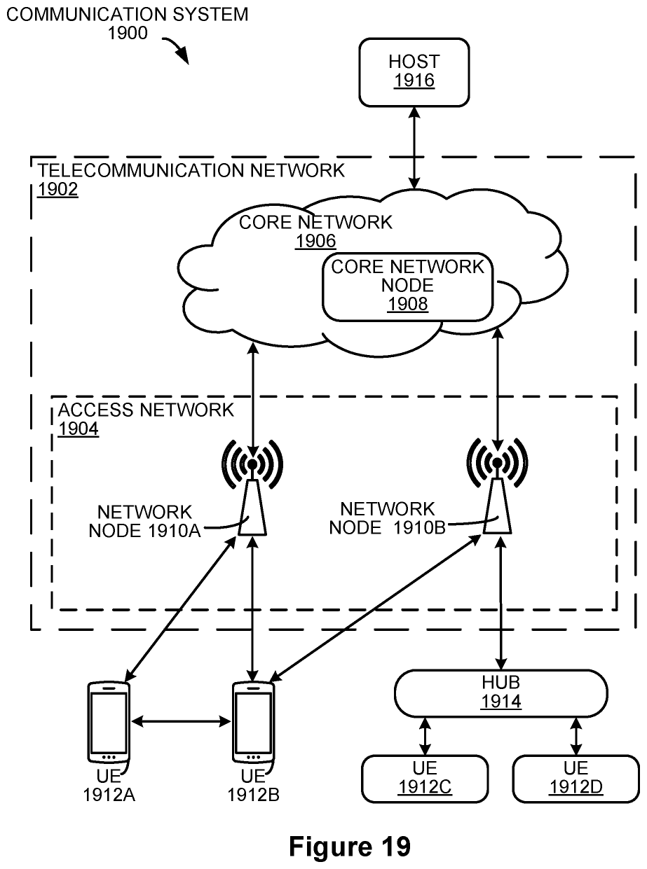

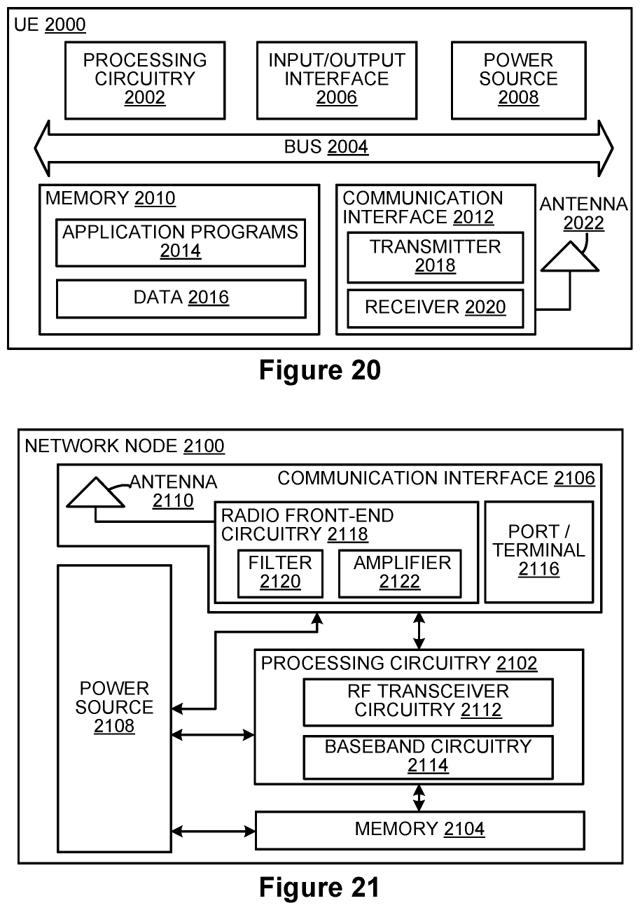

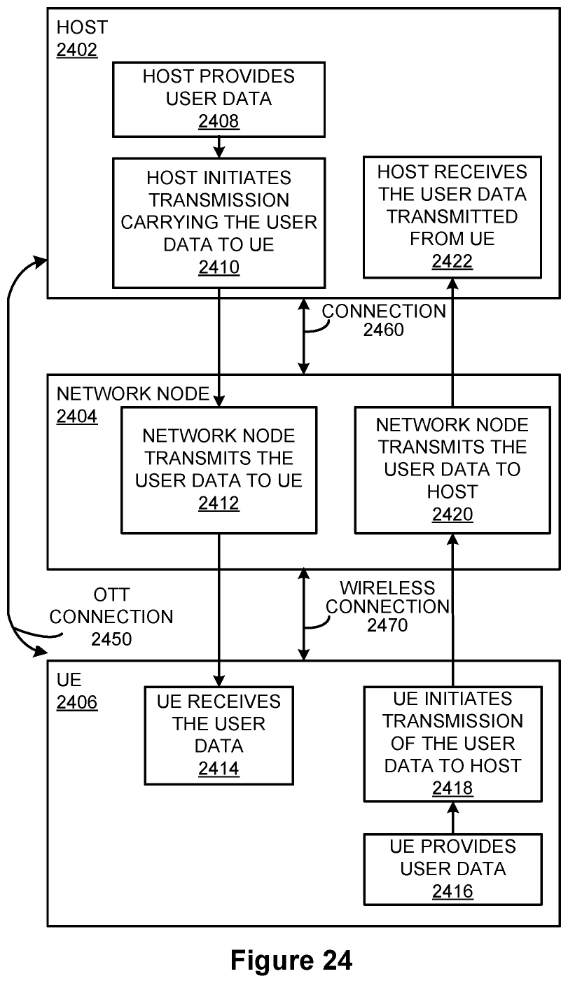

FIG. 2 is a block diagram illustrating elements of a communication device UE 110 (also referred to as a mobile terminal, a mobile communication terminal, a wireless device, a wireless communication device, a wireless terminal, mobile device, a wireless communication terminal, user equipment, UE, a user equipment node/terminal/device, etc.) configured to provide wireless communication according to embodiments of inventive concepts. (Communication device UE 110 may be provided, for example, as discussed below with respect to wireless devices UE 1912A, UE 1912B, and wired or wireless devices UE 1912C, UE 1912D of FIG. 19, UE 2000 of FIG. 20, virtualization hardware 2304 and virtual machines 2308A, 2308B of FIG. 23, and UE 2406 of FIG. 24, all of which should be considered interchangeable in the examples and embodiments described herein and be within the intended scope of this disclosure, unless otherwise noted.) As shown, communication device UE 110 may include an antenna 207 (e.g., corresponding to antenna 2022 of FIG. 20), and transceiver circuitry 201 (also referred to as a transceiver, e.g., corresponding to interface 2012 of FIG. 20 having transmitter 2018 and receiver 2020) including a transmitter and a receiver configured to provide uplink and downlink radio communications with a base station(s) (e.g., corresponding to network node 1910A, 1910B of FIG. 19, network node 2100 of FIG. 21, and network node 2404 of FIG. 24 also referred to as a RAN node) of a radio access network. Communication device UE 110 may also include processing circuitry 203 (also referred to as a processor, e.g., corresponding to processing circuitry 2002 of FIG. 20, and control system 2312 of FIG. 23) coupled to the transceiver circuitry, and memory circuitry 205 (also referred to as memory, e.g., corresponding to memory 2010 of FIG. 19) coupled to the processing circuitry. The memory circuitry 205 may include computer readable program code that when executed by the processing circuitry 203 causes the processing circuitry to perform operations according to embodiments disclosed herein. According to other embodiments, processing circuitry 203 may be defined to include memory so that separate memory circuitry is not required. Communication device UE 110 may also include an interface (such as a user interface) coupled with processing circuitry 203, and/or communication device UE may be incorporated in a vehicle.

As discussed herein, operations of communication device UE 110 may be performed by processing circuitry 203 and/or transceiver circuitry 201. For example, processing circuitry 203 may control transceiver circuitry 201 to transmit communications through transceiver circuitry 201 over a radio interface to a radio access network node (also referred to as a base station) and/or to receive communications through transceiver circuitry 201 from a RU node over a radio interface. Moreover, modules may be stored in memory circuitry 205, and these modules may provide instructions so that when instructions of a module are executed by processing circuitry 203, processing circuitry 203 performs respective operations (e.g., operations discussed below with respect to Example Embodiments relating to wireless communication devices). According to some embodiments, a communication device UE 110 and/or an element(s)/function(s) thereof may be embodied as a virtual node/nodes and/or a virtual machine/machines.

FIG. 3 is a block diagram illustrating elements of a radio unit, RU, node 108 (also referred to as a network node, and can be part of a base station, eNodeB/eNB, gNodeB/gNB, etc.) configured to provide cellular communication according to embodiments of inventive concepts. (RU node 108 may be provided, for example, as discussed below with respect to network node 1910A, 1910B of FIG. 19, network node 2100 of FIG. 21, hardware 2304 or virtual machine 2308A, 2308B of FIG. 23, and/or base station 2404 of FIG. 24, all of which should be considered interchangeable in the examples and embodiments described herein and be within the intended scope of this disclosure, unless otherwise noted.) As shown, the RU node may include transceiver circuitry 301 (also referred to as a transceiver, e.g., corresponding to portions of RF transceiver circuitry 2112 and radio front end circuitry 2118 of FIG. 21) including a transmitter and a receiver configured to provide uplink and downlink radio communications with mobile terminals. The RU node 108 may include network interface circuitry 307 (also referred to as a network interface, e.g., corresponding to portions of communication interface 2106 of FIG. 21) configured to provide communications with other nodes (e.g., with other DUs and base stations) of the network. The network node may also include processing circuitry 303 (also referred to as a processor, e.g., corresponding to processing circuitry 2102 of FIG. 21) coupled to the transceiver circuitry, and memory circuitry 305 (also referred to as memory, e.g., corresponding to memory 2104 of FIG. 21) coupled to the processing circuitry. The memory circuitry 305 may include computer readable program code that when executed by the processing circuitry 303 causes the processing circuitry to perform operations according to embodiments disclosed herein. According to other embodiments, processing circuitry 303 may be defined to include memory so that a separate memory circuitry is not required.

As discussed herein, operations of the RU node 108 may be performed by processing circuitry 303, network interface 307, and/or transceiver 301. For example, processing circuitry 303 may control transceiver 301 to transmit downlink communications through transceiver 301 over a radio interface to one or more mobile terminals UEs and/or to receive uplink communications through transceiver 301 from one or more mobile terminals UEs over a radio interface. Similarly, processing circuitry 303 may control network interface 307 to transmit communications through network interface 307 to one or more DU nodes and other network nodes and/or to receive communications through network interface from one or more DU nodes and other network nodes. Moreover, modules may be stored in memory 305, and these modules may provide instructions so that when instructions of a module are executed by processing circuitry 303, processing circuitry 303 performs respective operations (e.g., operations discussed below with respect to Example Embodiments relating to RU nodes). According to some embodiments, RU node 108 and/or an element(s)/function(s) thereof may be embodied as a virtual node/nodes and/or a virtual machine/machines.

FIG. 4 is a block diagram illustrating elements of a distributed unit (DU) node 106 of a communication network according to embodiments of inventive concepts. (DU node 106 may be provided, for example, as discussed below with respect to node 1908 of FIG. 19, hardware 2304 or virtual machine 2308A, 2308B of FIG. 23, all of which should be considered interchangeable in the examples and embodiments described herein and be within the intended scope of this disclosure, unless otherwise noted.) As shown, the DU node 106 may include network interface circuitry 407 configured to provide communications with RU nodes and interface 409 configured to provide communications with other nodes such as nodes of the core network and/or the communication network. The DU node 106 may also include processing circuitry 403 (also referred to as a processor,) coupled to the network interface circuitry, and memory circuitry 405 (also referred to as memory) coupled to the processing circuitry. The memory circuitry 405 may include computer readable program code that when executed by the processing circuitry 403 causes the processing circuitry to perform operations according to embodiments disclosed herein. According to other embodiments, processing circuitry 403 may be defined to include memory so that a separate memory circuitry is not required.

As discussed herein, operations of the DU node 106 may be performed by processing circuitry 403 and/or network interface circuitry 407. For example, processing circuitry 403 may control network interface circuitry 407 to transmit communications through network interface circuitry 407 to one or more other network nodes and/or to receive communications through network interface circuitry from one or more other network nodes. Moreover, modules may be stored in memory 405, and these modules may provide instructions so that when instructions of a module are executed by processing circuitry 403, processing circuitry 403 performs respective operations (e.g., operations discussed below with respect to Example Embodiments relating to core network nodes). According to some embodiments, DU node 106 and/or an element(s)/function(s) thereof may be embodied as a virtual node/nodes and/or a virtual machine/machines.

System model and mathematical explanation for IRC explicit split are described below.

Consider the scenario with K user-layers in a desired cell. In antenna space or beam space, the wireless communication channel from the target user(s) to the base station is denoted as H∈ [symbol] ^{N×K}, where N is the number of antennas or number of beams used in beam space of this base station. The transmit signals from the target users to this base station are denoted as x=[x₁, . . . xₖ, . . . , x_{K}]^{T}, where [x₁, . . . , x_{K}]^{T} is the transpose of vector [x₁, . . . , x_{K}] and xₖ is the transmit signal originating from the k-th user layer. Meanwhile, there are interference signals originating from users wirelessly connected to other base stations or base-station systems than this base station system received by this base-station system. The wireless propagation channel between the interfering users from other cells and this base station is denoted as H_{I}∈ [symbol] ^{N×J}, where J denotes the number of interfering signals. The interfering signals originating from the interfering users are denoted as x_{I}=[x_{I,1}, . . . , x_{I,j}, . . . , x_{I,J}]^{T}, where x_{I,j} denotes the interference signal originating from the j-th interfere. The uplink signals y=[y₁, . . . , y_{N}]^{T} as received at the N antennas or beams of this base station from the targeted users can be expressed as

$$y = Hx + {H}_{I} {x}_{I} + n = Hx + {n}_{I}$$

where n=[n₁, . . . , n_{N}]^{T}∈ [symbol] ^{N×1} denotes the additive background noise and n_{I}=H_{I}x_{I}+n denotes the received interference plus noise (IpN). The received uplink signals, therefore, comprises K user-layer signals overlaid with interference signals and noise. The IpN covariance matrix of n_{I} is Q=E{n_{I}n_{I}^{H}}, where n_{I}^{H} denotes Hermitian transpose of n_{I}. In practice, Q can be estimated by the receiver in various ways under different estimation criteria, e.g., least squares (LS), minimum mean-squared error (MMSE), linear minimum mean-squared error (LMMSE) etc., based on, for example, reference signals like sounding reference signal (SRS), demodulation reference signal (DMRS), and other information like signal to interference and noise ratio (SINR) estimate and UE feedback on channel conditions (e.g., channel quality indicator, channel state information), as well as the channel estimates. The IRC beamforming coefficients can be formulated as

$${W}_{IRC} = {{H}^{H} ( {HH}^{H} + {σ}^{2} Q )}^{- 1}$$

where σ² is a regularization factor. In some embodiments, σ²=1. In practice, the estimates of H and Q are used to calculate W_{IRC}. To be simplified and without losing generality, the original quantity and its estimated version hereinafter shall not be differentiated. Only H and Q will be used in mathematical explanation for convenience.

Consider one variant of the Woodbury formula (i.e., matrix inversion lemma) CU(A+VCU)⁻¹=(C⁻¹+UA⁻¹V)⁻¹UA⁻¹ where A, U, C and V are conformable matrices: A is n×n, C is k×k, U is k×n, and V is n×k. The IRC equalizer can also be written as:

$${W}_{IRC} = {( {H}^{H} {Q}^{- 1} H + {σ}^{2} I )}^{- 1} {H}^{H} {Q}^{- 1}$$

Note that in the original formulation (i.e., W_{IRC}=H^{H}(HH^{H}+σ²Q)⁻¹, the right-hand side term (HH^{H}+Q)⁻¹ is an N×N matrix. When multiplying with the UL received signal y, the output will still be an N-dimensional vector. However, if the re-written formulation is used, the right-hand side term H^{H}Q⁻¹ is a K×N matrix. When multiplying with the UL received signal y, the dimension of the output vector will be reduced from N to K. So, if this part of beamforming is located in the RU, the number of UL data streams over the fronthaul interface can be effectively reduced to the number of layers, K.

By taking advantage of the IRC formulation as rewritten (i.e., W_{IRC}=(H^{H}Q⁻¹H+σ²I)⁻¹H^{H}Q⁻¹), the various embodiments of inventive concepts split the IRC BFWs calculation as well as the associated beamforming into two phases in various ways. The first phase in the RU calculates the first part BFWs

$${W}_{1} = {H}^{H} {Q}^{- 1}$$

and conducts the first part beamforming which yields intermediate beamformed UL data signals according to

$${y}_{1} ∈ {K \times 1}^{} = {W}_{1} y$$

The first part beamforming also gives an effective channel of

$${H}_{eff} = {W}_{1} H = {H}^{H} {Q}^{- 1} H$$

With this formulation, H_{eff} is a Hermitian matrix since the covariance matrix Q is a Hermitian matrix, i.e., Q=Q^{H} and therefore H_{eff}=H_{eff}^{H}. In one embodiment, H_{eff} can be sent from the RU to the BBU (or the DU) to assist the BBU (or the DU) to perform its beamforming operation. Note that the terms BBU and DU may be used interchangeably in the following description and denotes the same network node or function or part of the node or function hosting the baseband processing, e.g., the part related to IRC processing. Utilizing the Hermitian property of H_{eff}, only transporting a subset of components of H_{eff} is enough to convey the information carried by H_{eff}. For example, transporting the upper triangular components of H_{eff} or transporting the lower triangular components of H_{eff} is enough to convey the information carried by H_{eff}. Other subsets may be used provided that H_{eff} can be recovered from the subset. The upper triangular components of H_{eff} are composed by all the entries above and including the main diagonal entries. The lower triangular components of H_{eff} are composed by all the entries below and including the main diagonal entries. In this case, the number of components for H_{eff} that needs to be transported is reduced from K² to (K²+K)/2. H_{eff} in frequency domain can represent a great amount of data, e.g., when H_{eff} per subcarrier needs to be sent to achieve the best performance. Sending only the upper triangular or lower triangular components of H_{eff} would reduce the fronthaul bit rate by almost 50% for sending the information regarding H_{eff} from RU to BBU and therefore significantly reduce fronthaul load in the UL direction without degrading the performance. If only the upper triangular components of H_{eff}, denoted by H_{eff,u} is transported, the original Hermitian matrix H_{eff} can be recovered as

$${H}_{eff} ( k , {k}^{′} ) = \{ \begin{matrix}{H}_{eff , u} ( k , {k}^{′} ) & if k \leq {k}^{′} \\ {[ {H}_{eff , u} ( {k}^{′} , k ) ]}^{*} & if k > {k}^{′}\end{matrix}$$

where [H_{eff,u}(k′,k)]* denotes the complex conjugate of H_{eff,u}(k′, k).

If only the lower triangular components of H_{eff}, denoted by H_{eff,l} is transported, the original Hermitian matrix H_{eff} can be recovered as

$${H}_{eff} ( k , {k}^{′} ) = \{ \begin{matrix}{[ {H}_{eff , l} ( {k}^{′} , k ) ]}^{*} & if k < {k}^{′} \\ {H}_{eff , l} ( k , {k}^{′} ) & if k \geq {k}^{′}\end{matrix}$$

The second phase in the DU calculates the second BFWs as

$${W}_{2} = {( {H}^{H} {Q}^{- 1} H + {σ}^{2} I )}^{- 1} = {( {H}_{eff} + {σ}^{2} I )}^{- 1}$$

The second beamforming is performed as

r=W₂y₁

where r is the estimation of the K user-layers signals.

Combining the two phases, an IRC receiver is effectively realized as W_{IRC}=W₂W₁.

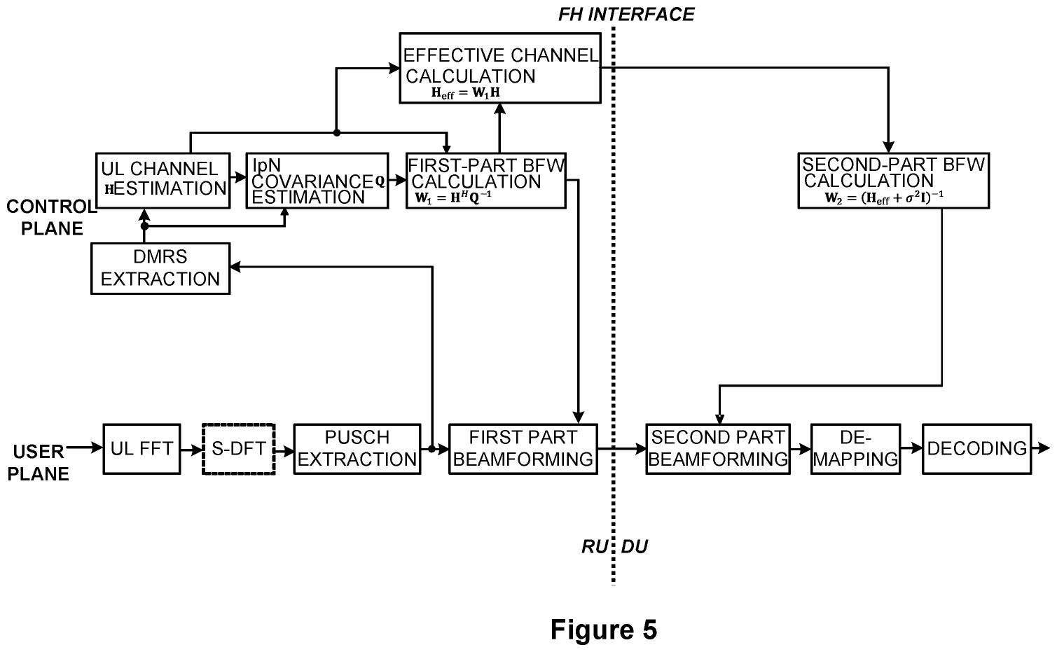

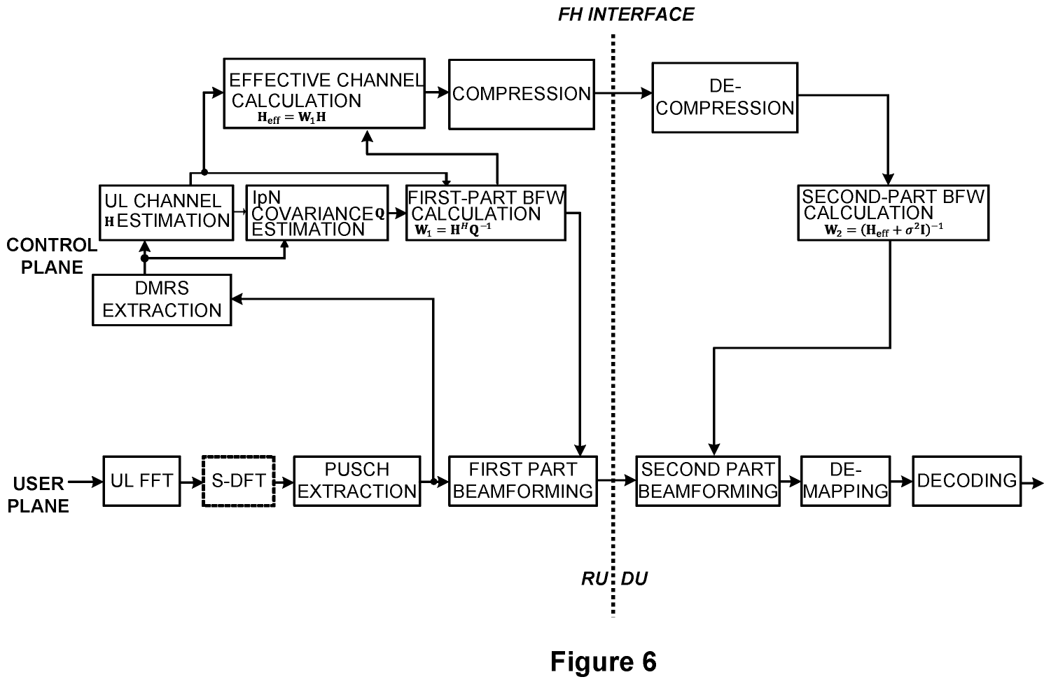

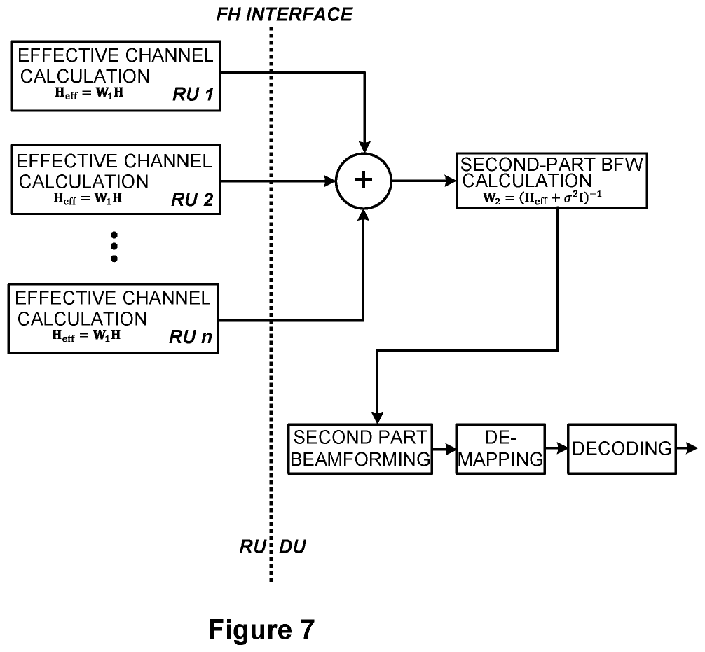

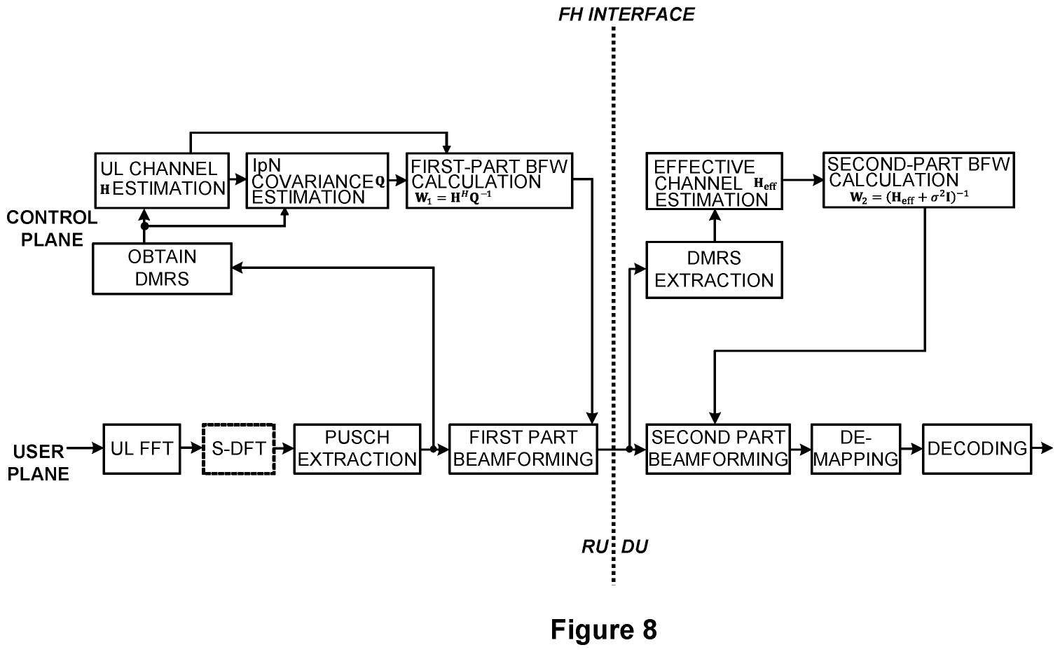

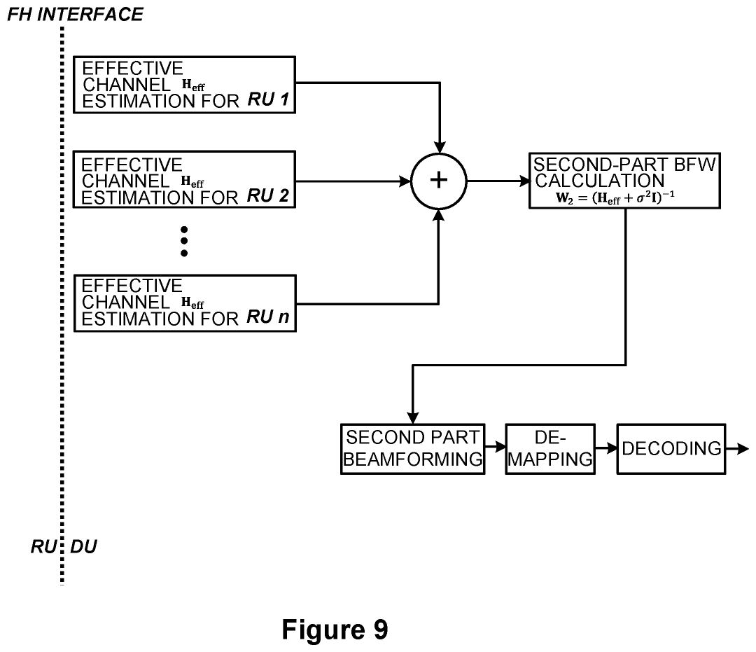

FIGS. 5-9 illustrate block diagrams of various embodiments of inventive concepts. FIG. 5 is a block diagram illustrating a radio unit determining an effective channel matrix H_{eff} and providing the determined effective channel matrix H_{eff} to a distributed unit according to some embodiments of inventive concepts. FIG. 6 is a block diagram illustrating a determined effective channel matrix H_{eff} being compressed by a radio unit according to some embodiments of inventive concepts. FIG. 7 is a block diagram illustrating a plurality of radio units determining an effective channel matrix H_{eff} and providing the determined effective channel matrix H_{eff} to a distributed unit according to some embodiments of inventive concepts. FIG. 8 is a block diagram illustrating a distributed unit estimating an effective channel matrix H_{eff} according to some embodiments of inventive concepts. FIG. 9 is a block diagram illustrating a distributed unit estimating an effective channel matrix H_{eff} based on a plurality of radio units according to some embodiments of inventive concepts.

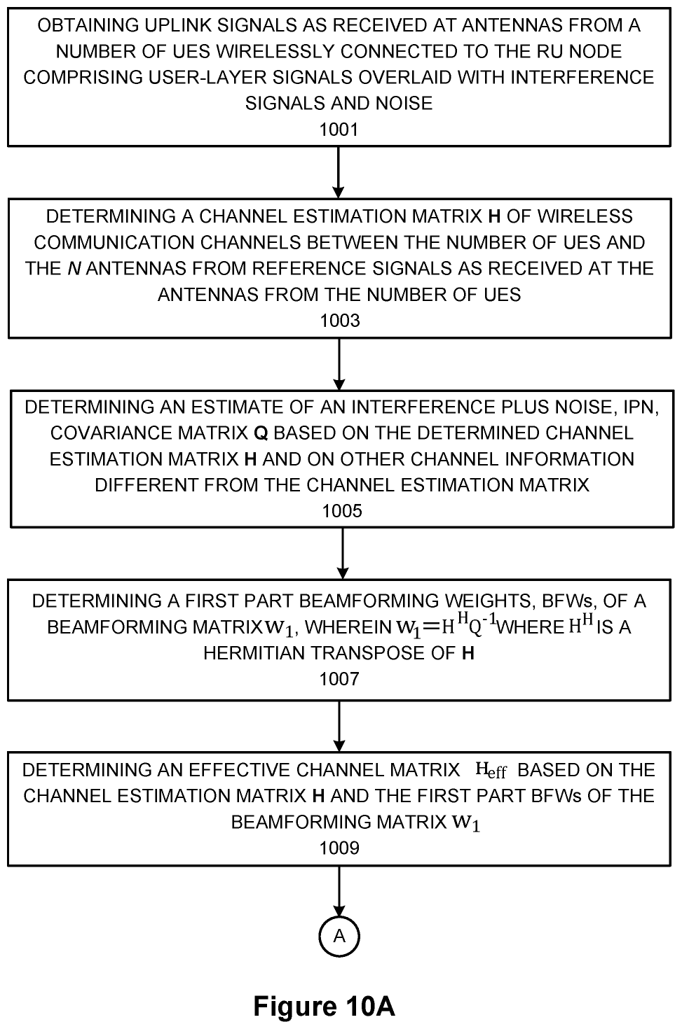

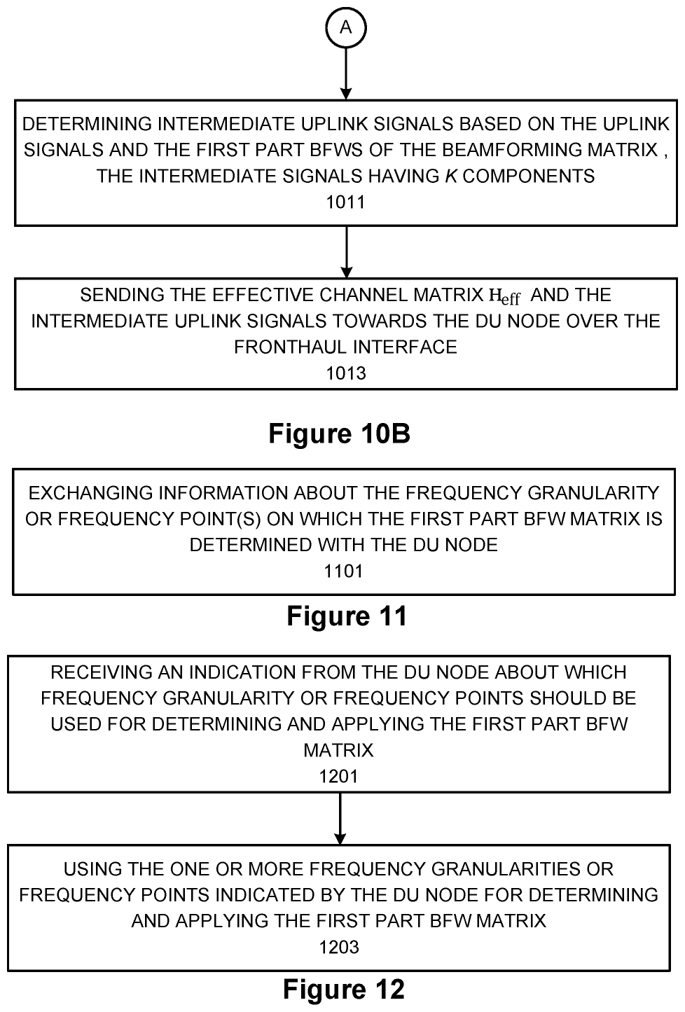

In the description that follows, while the RU node may be any of the RU node 108, network node 1910A, 1910B, 2100, 2406, hardware 2304, or virtual machine 2308A, 2308B, the RU node 108 shall be used to describe the functionality of the operations of the network node. Operations of the RU node 108 (implemented using the structure of FIG. 3) will now be discussed with reference to the flow chart of FIGS. 10A-10B according to some embodiments of inventive concepts. For example, modules may be stored in memory 305 of FIG. 3, and these modules may provide instructions so that when the instructions of a module are executed by respective RU node processing circuitry 303, processing circuitry 303 performs respective operations of the flow chart.

FIGS. 10A-10B illustrate a method performed by a radio unit, RU, node 108 of a base station system 100 for performing frequency-domain beamforming for a communication between a base station and a plurality of User Equipments, UEs, 110 in a network adapted to use a multiple antenna system for communication, the base station system 100 further comprising a distributed unit, DU, node 106 connected to the RU node 108 over a fronthaul interface, the RU node 108 being connected to N antennas. Note that in some embodiments, DU node 106 is implemented in a cloud environment where different modules perform functions of the DU node 106. In other embodiments, the functions of the DU node 106 may be implemented by the baseband unit 102 as software.

Turning to FIG. 10A, in block 1001, the processing circuitry 303 obtains uplink signals (e.g., uplink signals y) as received at N antennas from a number of UEs, wirelessly connected to the RU, the N uplink signals comprising K user-layer signals overlaid with interference signals and noise.

In block 1003, the processing circuitry 303 determines a channel estimation matrix H of wireless communication channels between a number of UEs 110 and N antennas from reference signals as received at the N antennas from the number of UEs 110.

In block 1005, the processing circuitry 303 determines an estimate of an Interference plus Noise, IpN, covariance matrix Q based on the channel estimation matrix H and on other channel information different from the channel estimation matrix.

In some embodiments, the other channel information can be the received reference signals such as a sounding reference signal (SRS), a demodulation reference signal (DMRS) and other information such as a signal to interference and noise ratio (SINR) estimate and UE feedback on channel conditions.

In some other embodiments, the determination of the estimation of the IpN covariance matrix Q is based on multiple determined channel estimation matrices and on other channel information different from the channel estimation matrices.

In block 1007, the processing circuitry 303 determines a first part beamforming weights, BFWs, of a beamforming matrix W₁, wherein W₁=H^{H}Q⁻¹ where H^{H} is a Hermitian transpose of H.

In some embodiments of inventive concepts, the frequency granularity or frequency point(s) on which the first BFW matrix W₁ is determined at the RU node 108 is (or, in some embodiments, should be) the same as the frequency granularity or frequency point(s) on which the second BFW matrix W₂ is determined at the DU node 106. In other words, the frequency granularity of W₁ should be aligned with W₂ to achieve the best performance. For example, if W₂ is calculated per subcarrier, i.e., resource element (RE), and applied on each subcarrier on the received IQ data at the DU node 106, W₁ should be calculated per subcarrier as well and applied on each subcarrier in RU node 108. If W₂ is calculated per subcarrier group, e.g. per resource block (RB) comprising of 12 subcarriers, and applied on each subcarrier in each subcarrier group on the received IQ data at the DU node 106, W₁ should be calculated on the frequency granularity per a group of subcarriers and each W₁ per subcarrier group is applied on each subcarrier in each group of the subcarriers in the RU node 108. This improves performance compared with if the RU node 108 uses different frequency granularity or frequency point(s) to determine W₁ than that used by DU node 106 to determine W₂.

Further, better performance is achieved with higher frequency granularity at the cost of the computational complexity for calculating more BFWs. When the RU node 108 and the DU node 106 are from different vendors, the frequency granularity to be used needs to be coordinated and agreed. Thus, as indicated in block 1101 of FIG. 11, the processing circuitry 303 exchanges information about the frequency granularity or frequency point(s) on which the first part BFW matrix W₁ is determined with the DU node 106.

In some embodiments, the RU node 108 reports its capability (e.g., via management-plane, M-plane) to the DU node 106 regarding the frequency granularities the RU node 106 supports. Thus, exchanging information about the frequency granularity or frequency point(s) on which the first part BFW matrix W₁ is determined with the DU node 106 includes the processing circuitry 303 providing RU capability to the DU regarding at least one of:
one or more possible frequency granularities or frequency points on which the channel estimates H and/or the estimated Interference plus Noise, IpN, covariance matrix Q can be obtained; and
one or more possible frequency granularities or frequency points on which the first part BFW matrix W₁ can be calculated and applied.

The RU node 108 then receives an indication from the DU node 106 about which frequency granularity or frequency points the RU node 108 should use for determining and applying the first part BFWs matrix W₁. This is illustrated in FIG. 12.

Turning to FIG. 12, in block 1201, the processing circuitry 303 receives an indication from the DU node 106 about which frequency granularity or frequency points should be used for determining and applying the first part BFW matrix W₁. In block 1203, the processing circuitry 303 uses the one or more frequency granularities or frequency points indicated by the DU for determining and applying the first part BFW matrix W₁.

In another embodiment of inventive concepts, the frequency granularity can be dynamically reconfigured. In this case, the indication of the frequency granularity to be used can be sent from the DU node 106 to the RU node 108 via management-plane (M-plane) messages in a slow manner and via control-plane (C-plane) messages in a faster manner, e.g., per slot (e.g., every 0.5 milliseconds (ms) for a 5G system using 30 kHz subcarrier spacing).

Returning to FIG. 10A, in block 1009, the processing circuitry 303 determines an effective channel matrix H_{eff} based on the channel estimation matrix H and the first part BFWs of the beamforming matrix W₁. In some embodiments, H_{eff} is determined in accordance with H_{eff}=W₁H. This is illustrated in FIG. 5.

Turning to FIG. 10B, in block 1011, the processing circuitry 303 determines intermediate uplink signals y₁, based on the uplink signals y and the determined first part BFWs of the beamforming matrix W₁, the intermediate signals having K components.

In block 1013, the processing circuitry 303 sends the effective channel matrix H_{eff} and the intermediate uplink signals towards the DU node 106 over the fronthaul interface. This is illustrated in FIG. 5.

In some embodiments, the processing circuitry 303 compresses the effective channel matrix H_{eff} and sends the compressed effective channel matrix towards the DU node 106. This is illustrated in FIG. 6 where the effective channel matrix H_{eff} is compressed in the compression block and decompressed by the DU node 106 in the de-compression block.

As indicated above, H_{eff} is a Hermitian matrix. Thus, in some embodiments of inventive concepts, by utilizing the Hermitian property of H_{eff}, only transporting the upper triangular or lower triangular components of H_{eff} is enough to convey the information carried by H_{eff}. The upper triangular components of H_{eff} are composed by all the entries above and including the main diagonal entries. The lower triangular components of H_{eff} are composed by all the entries below and including the main diagonal entries.

As illustrated in FIG. 7, each RU node 108 (e.g., RU₁ to RUₙ in FIG. 1) in some embodiments of inventive concepts transmits the effective channel matrix H_{eff} determined by the RU node 108 to the DU node 106 where the effective channel matrices received are summed as explained below. Note that each effective channel matrix H_{eff} determined by an RU node 108 may be compressed by the RU node 108 as illustrated in FIG. 6.

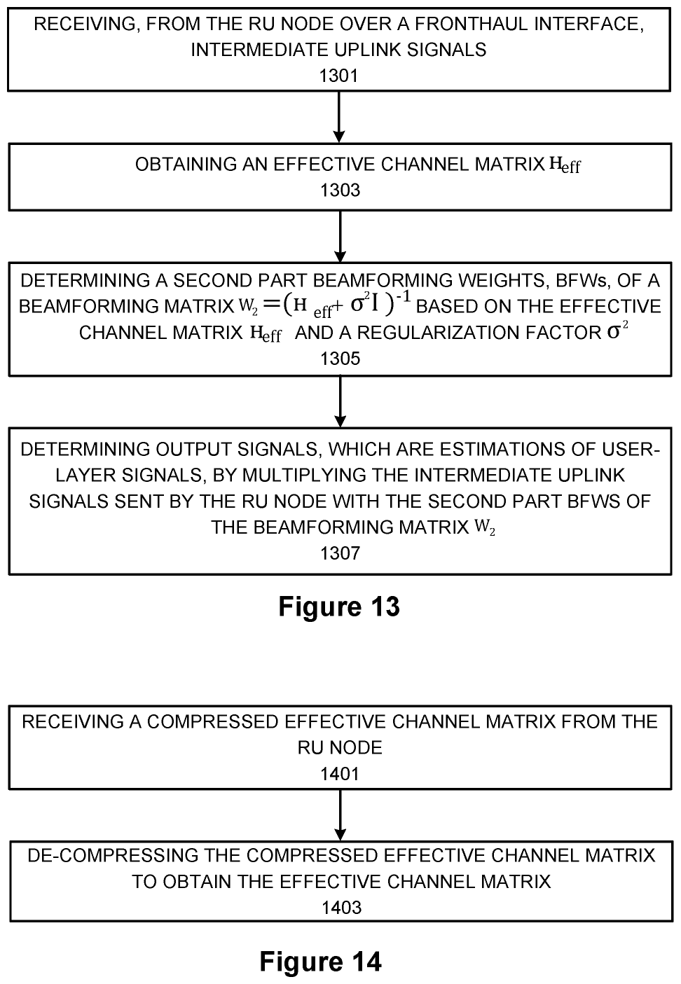

In the description that follows, while the DU node may be any of the DU node 106, hardware 2304, or virtual machine 2308A, 2308B, the DU node 106 shall be used to describe the functionality of the operations of the network node. Operations of the Core Network DU node 106 (implemented using the structure of FIG. 4) will now be discussed with reference to the flow chart of FIG. 13 according to some embodiments of inventive concepts. For example, modules may be stored in memory 405 of FIG. 4, and these modules may provide instructions so that when the instructions of a module are executed by respective DU node processing circuitry 403, processing circuitry 403 performs respective operations of the flow chart.

FIG. 13 illustrates a method performed by a Distributed Unit, DU, node 106 for assisting a Radio Unit, RU, node 108 to perform beamforming for a communication between a base station and a plurality of User Equipments, UEs, 110 in a wireless communications network using a multiple antenna system for communication, wherein the DU node 106 and the RU node 108 are associated with the base station 102.

Turning to FIG. 13, in block 1301, the processing circuitry 403 receives, from the RU node 108 over a fronthaul interface, intermediate signals (e.g., intermediate signals y₁).

In block 1303, the processing circuitry 403 obtains an effective channel matrix H_{eff}.

In some embodiments, the processing circuitry 403 receives the effective channel matrix H_{eff} from the RU node 108. In some of these embodiments as illustrated in FIG. 14, the processing circuitry 403 receives, in block 1401, a compressed effective channel matrix H_{eff} from the RU node 108. In block 1403, the processing circuitry 403 de-compresses the compressed effective channel matrix H_{eff} to obtain the effective channel matrix H_{eff}.

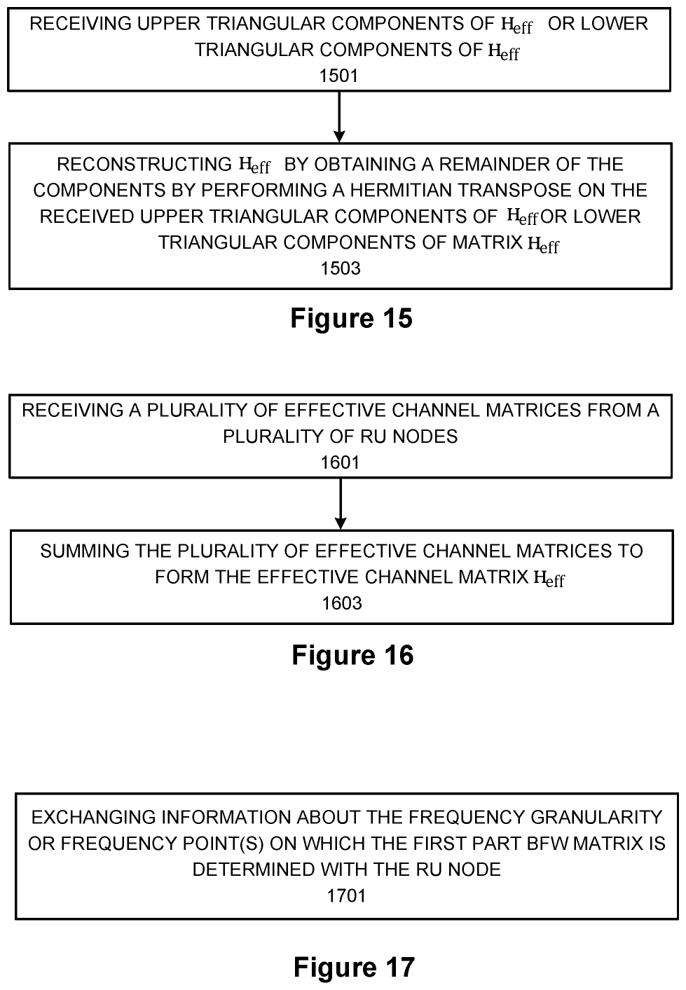

As previously described, H_{eff} is a Hermitian matrix. Thus, in some embodiments of inventive concepts, by utilizing the Hermitian property of H_{eff}, only transporting the upper triangular or lower triangular components of H_{eff} is enough to convey the information carried by H_{eff}. The upper triangular components of H_{eff} are composed by all the entries above and including the main diagonal entries. The lower triangular components of H_{eff} are composed by all the entries below and including the main diagonal entries. This is illustrated in FIG. 15, where in block 1501, the processing circuitry 403 receives upper triangular components of H_{eff} or lower triangular components of H_{eff}. In block 1503, the processing circuitry 403 reconstructs H_{eff} by obtaining a remainder of the components by performing a complex conjugate on the received upper triangular components of H_{eff} or lower triangular components of H_{eff}.

In some embodiments as illustrated in FIG. 7, a plurality of RU nodes 108 may each send an effective channel matrix H_{eff} towards the DU node 106. FIG. 16 is a flowchart illustrating the operation of some of these embodiments.

Turning to FIG. 16, in block 1601, the processing circuitry 403 receives a plurality of effective channel matrices from a plurality of RUs. In block 1603, the processing circuitry 403 sums the plurality of effective channel matrices to form the effective channel matrix H_{eff}.

In other embodiments of inventive concepts as illustrated in FIGS. 8 and 9, the processing circuitry 403 obtains an effective channel matrix H_{eff} by estimating the effective channel matrix H_{eff}. In some of these other embodiments, the processing circuitry 403 estimates the effective channel matrix H_{eff} by estimating the effective channel matrix H_{eff} using reference signals as received from at least part of the intermediate uplink signals.

In some other embodiments of these other embodiments, for each RU node 108 of a plurality of RU nodes 108 (connected to the DU node 106), the processing circuitry 403 estimates an effective channel matrix H_{eff} for the RU node 108 to form an estimated effective channel matrix H_{eff} for the RU node 108. For the plurality of RU nodes 108, the processing circuitry 403 sums each estimated effective channel matrix H_{eff} to form a summed estimated effective channel matrix. The processing circuitry 403 estimates the effective channel matrix H_{eff} by setting the effective channel matrix H_{eff} to the summed estimated effective channel matrix.

In cases where more than one RU nodes 108 connect to the same DU node 106, each RU nodes 108 performs the same as described above. The DU 106 obtains an effective channel matric for each of the RU nodes 108 as illustrated in FIGS. 7 and 9. Then, if joint processing of signals from multiple RU nodes 108 is desired, the DU node 106 sums the effective channel matrices of all connected RU nodes 108 and uses the resulting summed effective channel matrix to calculate the second part BFWs W₂. An example of one way to sum the effective channels is as follows:

Consider the case of L RUs connecting to the same DU, which serves a total number of K user layers. Let Kₗ (for Kₗ≤K) denote the number of user layers served by RU l for l=1, . . . , L. The indices of the Kₗ user layers out of the K user layers are in set [symbol] ₗ. Note that for any l≠k, the intersection of [symbol] ₗ and [symbol] ₖ can either be empty or non-empty. Let H_{eff,l}∈ [symbol] ^{K}^{ₗ}^{×K}^{ₗ} denote the effective channel determined for RU l. Define an extended effective channel H̅_{eff,l}∈ [symbol] ^{K×K} for RU l as

$${\overline{H}}_{eff , l} ( k , {k}^{′} ) = \{ \begin{matrix}{H}_{eff , l} ( i , j ) & if k = {l}_{} \{ i \} and {k}^{′} = {l}_{} \{ j \} \\ 0 & if k ∉ {l}_{} or {k}^{′} ∉ {l}_{}\end{matrix}$$

The joint effective channel H_{eff}∈ [symbol] ^{K×K} of the L RUs can be obtained as

$${H}_{eff} = {\sum }_{l = 1}^{L} {\overline{H}}_{eff , l}$$

Returning to FIG. 13, in block 1305, the processing circuitry 403 determines a second part Beamforming Weights, BFWs, of a beamforming matrix W₂=(H_{eff}+σ²I)⁻¹ based on the effective channel matrix H_{eff} and a regularization factor σ².

The regularization factor σ² is a non-negative real value. For example, the regularization factor σ² is based on the effective channel matrix H_{eff} in some embodiments of inventive concepts.

In various embodiments, the frequency granularity or on which frequency points the second BFW matrix W₂ is determined and applied at the DU node 106 is the same as the frequency granularity or on which frequency points the first BFW matrix W₁ is determined and applied at the RU node 108. In this case, information about the frequency granularity or frequency point on which the second part BFW matrix W₂ is determined is exchanged between DU node 106 and RU node 108. This is illustrated in FIG. 17 where in block 1701, the processing circuitry 403 exchanges information about the frequency granularity and frequency point(s) on which the second part BFW matrix W₂ is determined with the RU node 108.

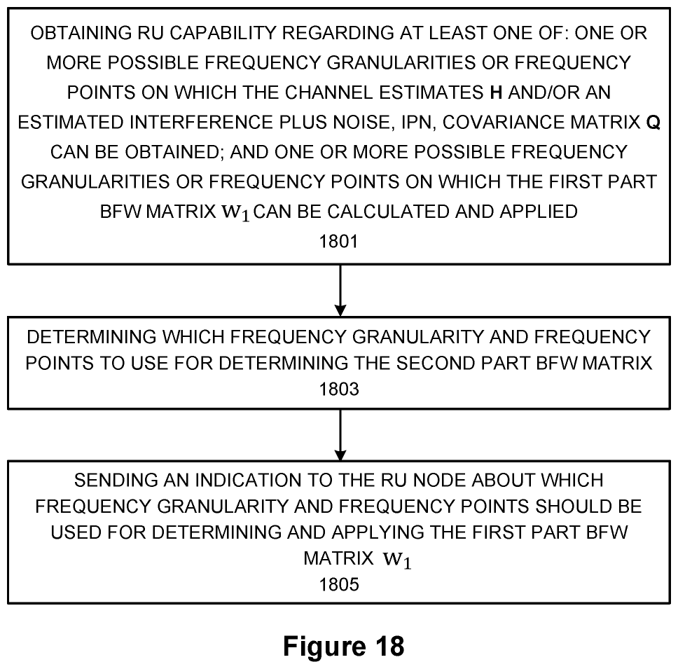

FIG. 18 illustrates an embodiment where the information is exchanged. Turning to FIG. 18, in block 1801, the processing circuitry 403 obtains (e.g., via M-plane) information about RU's capability regarding the frequency granularities it supports, comprising of at least one of:
possible frequency granularity(-ies) or frequency point(s) on which the channel estimates H and/or the estimated IpN covariance matrix Q can be obtained;
possible frequency granularity(-ies) or frequency point(s) on which the first part BFW matrix W₁ can be calculated.

In block 1803, the processing circuitry 403 determines which frequency granularity or frequency points to use for determining the second part BFW matrix W₂. To achieve the best performance, the highest frequency granularity that the DU node 106 and the RU node 108 commonly support should be determined. If the information regarding H_{eff} is sent over fronthaul from the RU node 108 to the DU node 106, a lower frequency granularity may be selected to reduce the fronthaul load in the UL direction. A lower frequency granularity may also be determined considering processing power and/or power consumption, since the computational complexity is lower at lower frequency granularity.

In some embodiments, the processing circuitry 403 determines the frequency points to use by obtaining the frequency points from a table, as a function of parameters (e.g., subcarrier spacing, occupied bandwidth, etc.), etc.

In block 1805, the processing circuitry 403 sends an indication to the RU node 108 about which frequency granularity and frequency points should be used for determining and applying the first part BFW matrix W₁.

In another embodiment of inventive concepts, the frequency resolution can be dynamically reconfigured. In this case, the indication of the frequency resolution to be used can be sent from the DU node 106 to the RU node 108 via M-plane messages in a slow manner and via C-plane messages in a faster manner, e g. per slot (e.g., every 0.5 ms for a 5G system using 30 kHz subcarrier spacing)

Returning to FIG. 13, in block 1307, the processing circuitry 403 determines output signals (e.g., output signals r), which are estimations of K user-layers signals, by multiplying the intermediate uplink signals (e.g., uplink signals y₁) sent by the RU node 108 with the second part BFWs of the beamforming matrix W₂.

FIG. 19 shows an example of a communication system 1900 in accordance with some embodiments.

In the example, the communication system 1900 includes a telecommunication network 1902 that includes an access network 1904, such as a radio access network (RAN), and a core network 1906, which includes one or more core network nodes 1908. The access network 1904 includes one or more access network nodes, such as network nodes 1910a and 1910b (one or more of which may be generally referred to as network nodes 1910), or any other similar 3^{rd} Generation Partnership Project (3GPP) access node or non-3GPP access point. The network nodes 1910 facilitate direct or indirect connection of user equipment (UE), such as by connecting UEs 1912a, 1912b, 1912c, and 1912d (one or more of which may be generally referred to as UEs 1912) to the core network 1906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1900 may include any number of wired or wireless networks, network nodes, UEs, and/or any other components or systems that may facilitate or participate in the communication of data and/or signals whether via wired or wireless connections. The communication system 1900 may include and/or interface with any type of communication, telecommunication, data, cellular, radio network, and/or other similar type of system.

The UEs 1912 may be any of a wide variety of communication devices, including wireless devices arranged, configured, and/or operable to communicate wirelessly with the network nodes 1910 and other communication devices. Similarly, the network nodes 1910 are arranged, capable, configured, and/or operable to communicate directly or indirectly with the UEs 1912 and/or with other network nodes or equipment in the telecommunication network 1902 to enable and/or provide network access, such as wireless network access, and/or to perform other functions, such as administration in the telecommunication network 1902.

In the depicted example, the core network 1906 connects the network nodes 1910 to one or more hosts, such as host 1916. These connections may be direct or indirect via one or more intermediary networks or devices. In other examples, network nodes may be directly coupled to hosts. The core network 1906 includes one more core network nodes (e.g., core network node 1908) that are structured with hardware and software components. Features of these components may be substantially similar to those described with respect to the UEs, network nodes, and/or hosts, such that the descriptions thereof are generally applicable to the corresponding components of the core network node 1908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1916 may be under the ownership or control of a service provider other than an operator or provider of the access network 1904 and/or the telecommunication network 1902, and may be operated by the service provider or on behalf of the service provider. The host 1916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1900 of FIG. 19 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1902 is a cellular network that implements 3GPP standardized features. Accordingly, the telecommunications network 1902 may support network slicing to provide different logical networks to different devices that are connected to the telecommunication network 1902. For example, the telecommunications network 1902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1912 are configured to transmit and/or receive information without direct human interaction. For instance, a UE may be designed to transmit information to the access network 1904 on a predetermined schedule, when triggered by an internal or external event, or in response to requests from the access network 1904. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub 1914 communicates with the access network 1904 to facilitate indirect communication between one or more UEs (e.g., UE 1912c and/or 1912d) and network nodes (e.g., network node 1910b). In some examples, the hub 1914 may be a controller, router, content source and analytics, or any of the other communication devices described herein regarding UEs. For example, the hub 1914 may be a broadband router enabling access to the core network 1906 for the UEs. As another example, the hub 1914 may be a controller that sends commands or instructions to one or more actuators in the UEs. Commands or instructions may be received from the UEs, network nodes 1910, or by executable code, script, process, or other instructions in the hub 1914. As another example, the hub 1914 may be a data collector that acts as temporary storage for UE data and, in some embodiments, may perform analysis or other processing of the data. As another example, the hub 1914 may be a content source. For example, for a UE that is a VR headset, display, loudspeaker or other media delivery device, the hub 1914 may retrieve VR assets, video, audio, or other media or data related to sensory information via a network node, which the hub 1914 then provides to the UE either directly, after performing local processing, and/or after adding additional local content. In still another example, the hub 1914 acts as a proxy server or orchestrator for the UEs, in particular in if one or more of the UEs are low energy IoT devices.

The hub 1914 may have a constant/persistent or intermittent connection to the network node 1910b. The hub 1914 may also allow for a different communication scheme and/or schedule between the hub 1914 and UEs (e.g., UE 1912c and/or 1912d), and between the hub 1914 and the core network 1906. In other examples, the hub 1914 is connected to the core network 1906 and/or one or more UEs via a wired connection. Moreover, the hub 1914 may be configured to connect to an M2M service provider over the access network 1904 and/or to another UE over a direct connection. In some scenarios, UEs may establish a wireless connection with the network nodes 1910 while still connected via the hub 1914 via a wired or wireless connection. In some embodiments, the hub 1914 may be a dedicated hub—that is, a hub whose primary function is to route communications to/from the UEs from/to the network node 1910b. In other embodiments, the hub 1914 may be a non-dedicated hub—that is, a device which is capable of operating to route communications between the UEs and network node 1910b, but which is additionally capable of operating as a communication start and/or end point for certain data channels.

FIG. 20 shows a UE 2000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2000 includes processing circuitry 2002 that is operatively coupled via a bus 2004 to an input/output interface 2006, a power source 2008, a memory 2010, a communication interface 2012, and/or any other component, or any combination thereof. Certain UEs may utilize all or a subset of the components shown in FIG. 20. The level of integration between the components may vary from one UE to another UE. Further, certain UEs may contain multiple instances of a component, such as multiple processors, memories, transceivers, transmitters, receivers, etc.

The processing circuitry 2002 is configured to process instructions and data and may be configured to implement any sequential state machine operative to execute instructions stored as machine-readable computer programs in the memory 2010. The processing circuitry 2002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2002 may include multiple central processing units (CPUs).

In the example, the input/output interface 2006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2008 is structured as a battery or battery pack. Other types of power sources, such as an external power source (e.g., an electricity outlet), photovoltaic device, or power cell, may be used. The power source 2008 may further include power circuitry for delivering power from the power source 2008 itself, and/or an external power source, to the various parts of the UE 2000 via input circuitry or an interface such as an electrical power cable. Delivering power may be, for example, for charging of the power source 2008. Power circuitry may perform any formatting, converting, or other modification to the power from the power source 2008 to make the power suitable for the respective components of the UE 2000 to which power is supplied.

The memory 2010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2010 includes one or more application programs 2014, such as an operating system, web browser application, a widget, gadget engine, or other application, and corresponding data 2016. The memory 2010 may store, for use by the UE 2000, any of a variety of various operating systems or combinations of operating systems.

The memory 2010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2010 may allow the UE 2000 to access instructions, application programs and the like, stored on transitory or non-transitory memory media, to off-load data, or to upload data. An article of manufacture, such as one utilizing a communication system may be tangibly embodied as or in the memory 2010, which may be or comprise a device-readable storage medium.

The processing circuitry 2002 may be configured to communicate with an access network or other network using the communication interface 2012. The communication interface 2012 may comprise one or more communication subsystems and may include or be communicatively coupled to an antenna 2022. The communication interface 2012 may include one or more transceivers used to communicate, such as by communicating with one or more remote transceivers of another device capable of wireless communication (e.g., another UE or a network node in an access network). Each transceiver may include a transmitter 2018 and/or a receiver 2020 appropriate to provide network communications (e.g., optical, electrical, frequency allocations, and so forth). Moreover, the transmitter 2018 and receiver 2020 may be coupled to one or more antennas (e.g., antenna 2022) and may share circuit components, software or firmware, or alternatively be implemented separately.

In the illustrated embodiment, communication functions of the communication interface 2012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2000 shown in FIG. 20.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 21 shows a network node 2100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2100 includes a processing circuitry 2102, a memory 2104, a communication interface 2106, and a power source 2108. The network node 2100 may be composed of multiple physically separate components (e.g., a NodeB component and a RNC component, or a BTS component and a BSC component, etc.), which may each have their own respective components. In certain scenarios in which the network node 2100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2100 may be configured to support multiple radio access technologies (RATs). In such embodiments, some components may be duplicated (e.g., separate memory 2104 for different RATs) and some components may be reused (e.g., a same antenna 2110 may be shared by different RATs). The network node 2100 may also include multiple sets of the various illustrated components for different wireless technologies integrated into network node 2100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2100.

The processing circuitry 2102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2100 components, such as the memory 2104, to provide network node 2100 functionality.

In some embodiments, the processing circuitry 2102 includes a system on a chip (SOC). In some embodiments, the processing circuitry 2102 includes one or more of radio frequency (RF) transceiver circuitry 2112 and baseband processing circuitry 2114. In some embodiments, the radio frequency (RF) transceiver circuitry 2112 and the baseband processing circuitry 2114 may be on separate chips (or sets of chips), boards, or units, such as radio units and digital units. In alternative embodiments, part or all of RF transceiver circuitry 2112 and baseband processing circuitry 2114 may be on the same chip or set of chips, boards, or units.

The memory 2104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2102. The memory 2104 may store any suitable instructions, data, or information, including a computer program, software, an application including one or more of logic, rules, code, tables, and/or other instructions capable of being executed by the processing circuitry 2102 and utilized by the network node 2100. The memory 2104 may be used to store any calculations made by the processing circuitry 2102 and/or any data received via the communication interface 2106. In some embodiments, the processing circuitry 2102 and memory 2104 is integrated.

The communication interface 2106 is used in wired or wireless communication of signaling and/or data between a network node, access network, and/or UE. As illustrated, the communication interface 2106 comprises port(s)/terminal(s) 2116 to send and receive data, for example to and from a network over a wired connection. The communication interface 2106 also includes radio front-end circuitry 2118 that may be coupled to, or in certain embodiments a part of, the antenna 2110. Radio front-end circuitry 2118 comprises filters 2120 and amplifiers 2122. The radio front-end circuitry 2118 may be connected to an antenna 2110 and processing circuitry 2102. The radio front-end circuitry may be configured to condition signals communicated between antenna 2110 and processing circuitry 2102. The radio front-end circuitry 2118 may receive digital data that is to be sent out to other network nodes or UEs via a wireless connection. The radio front-end circuitry 2118 may convert the digital data into a radio signal having the appropriate channel and bandwidth parameters using a combination of filters 2120 and/or amplifiers 2122. The radio signal may then be transmitted via the antenna 2110. Similarly, when receiving data, the antenna 2110 may collect radio signals which are then converted into digital data by the radio front-end circuitry 2118. The digital data may be passed to the processing circuitry 2102. In other embodiments, the communication interface may comprise different components and/or different combinations of components.

In certain alternative embodiments, the network node 2100 does not include separate radio front-end circuitry 2118, instead, the processing circuitry 2102 includes radio front-end circuitry and is connected to the antenna 2110. Similarly, in some embodiments, all or some of the RF transceiver circuitry 2112 is part of the communication interface 2106. In still other embodiments, the communication interface 2106 includes one or more ports or terminals 2116, the radio front-end circuitry 2118, and the RF transceiver circuitry 2112, as part of a radio unit (not shown), and the communication interface 2106 communicates with the baseband processing circuitry 2114, which is part of a digital unit (not shown).

The antenna 2110 may include one or more antennas, or antenna arrays, configured to send and/or receive wireless signals. The antenna 2110 may be coupled to the radio front-end circuitry 2118 and may be any type of antenna capable of transmitting and receiving data and/or signals wirelessly. In certain embodiments, the antenna 2110 is separate from the network node 2100 and connectable to the network node 2100 through an interface or port.

The antenna 2110, communication interface 2106, and/or the processing circuitry 2102 may be configured to perform any receiving operations and/or certain obtaining operations described herein as being performed by the network node. Any information, data and/or signals may be received from a UE, another network node and/or any other network equipment. Similarly, the antenna 2110, the communication interface 2106, and/or the processing circuitry 2102 may be configured to perform any transmitting operations described herein as being performed by the network node. Any information, data and/or signals may be transmitted to a UE, another network node and/or any other network equipment.

The power source 2108 provides power to the various components of network node 2100 in a form suitable for the respective components (e.g., at a voltage and current level needed for each respective component). The power source 2108 may further comprise, or be coupled to, power management circuitry to supply the components of the network node 2100 with power for performing the functionality described herein. For example, the network node 2100 may be connectable to an external power source (e.g., the power grid, an electricity outlet) via an input circuitry or interface such as an electrical cable, whereby the external power source supplies power to power circuitry of the power source 2108. As a further example, the power source 2108 may comprise a source of power in the form of a battery or battery pack which is connected to, or integrated in, power circuitry. The battery may provide backup power should the external power source fail.

Embodiments of the network node 2100 may include additional components beyond those shown in FIG. 21 for providing certain aspects of the network node's functionality, including any of the functionality described herein and/or any functionality necessary to support the subject matter described herein. For example, the network node 2100 may include user interface equipment to allow input of information into the network node 2100 and to allow output of information from the network node 2100. This may allow a user to perform diagnostic, maintenance, repair, and other administrative functions for the network node 2100.

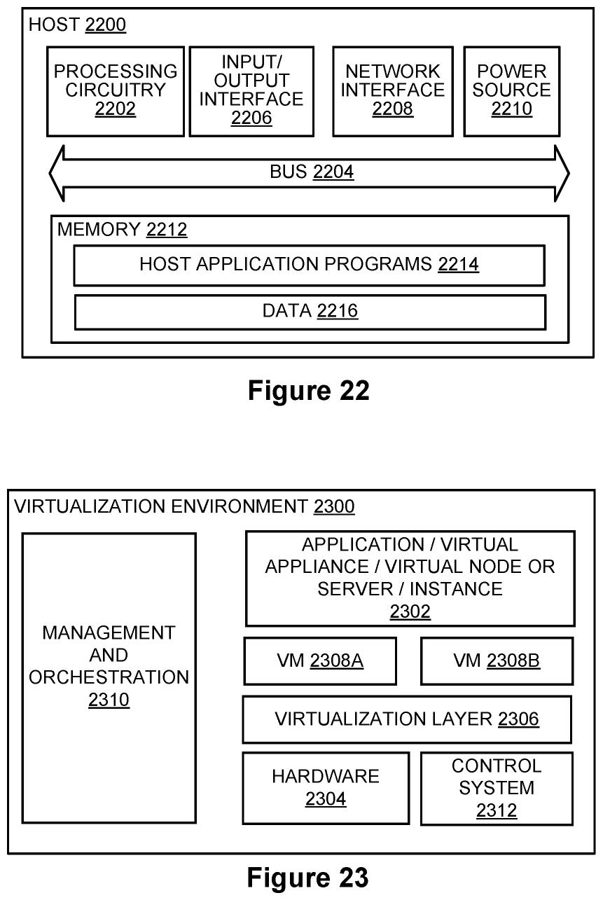

FIG. 22 is a block diagram of a host 2200, which may be an embodiment of the host 1916 of FIG. 19, in accordance with various aspects described herein. As used herein, the host 2200 may be or comprise various combinations hardware and/or software, including a standalone server, a blade server, a cloud-implemented server, a distributed server, a virtual machine, container, or processing resources in a server farm. The host 2200 may provide one or more services to one or more UEs.

The host 2200 includes processing circuitry 2202 that is operatively coupled via a bus 2204 to an input/output interface 2206, a network interface 2208, a power source 2210, and a memory 2212. Other components may be included in other embodiments. Features of these components may be substantially similar to those described with respect to the devices of previous figures, such as FIGS. 20 and 21, such that the descriptions thereof are generally applicable to the corresponding components of host 2200.

The memory 2212 may include one or more computer programs including one or more host application programs 2214 and data 2216, which may include user data, e.g., data generated by a UE for the host 2200 or data generated by the host 2200 for a UE. Embodiments of the host 2200 may utilize only a subset or all of the components shown. The host application programs 2214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2214 may also provide for user authentication and licensing checks and may periodically report health, routes, and content availability to a central node, such as a device in or on the edge of a core network. Accordingly, the host 2200 may select and/or indicate a different host for over-the-top services for a UE. The host application programs 2214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 23 is a block diagram illustrating a virtualization environment 2300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2306 (also referred to as hypervisors or virtual machine monitors (VMMs)), provide VMs 2308a and 2308b (one or more of which may be generally referred to as VMs 2308), and/or perform any of the functions, features and/or benefits described in relation with some embodiments described herein. The virtualization layer 2306 may present a virtual operating platform that appears like networking hardware to the VMs 2308.

The VMs 2308 comprise virtual processing, virtual memory, virtual networking or interface and virtual storage, and may be run by a corresponding virtualization layer 2306. Different embodiments of the instance of a virtual appliance 2302 may be implemented on one or more of VMs 2308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2308 may be a software implementation of a physical machine that runs programs as if they were executing on a physical, non-virtualized machine. Each of the VMs 2308, and that part of hardware 2304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2308 on top of the hardware 2304 and corresponds to the application 2302.

Hardware 2304 may be implemented in a standalone network node with generic or specific components. Hardware 2304 may implement some functions via virtualization. Alternatively, hardware 2304 may be part of a larger cluster of hardware (e.g., such as in a data center or CPE) where many hardware nodes work together and are managed via management and orchestration 2310, which, among others, oversees lifecycle management of applications 2302. In some embodiments, hardware 2304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2312 which may alternatively be used for communication between hardware nodes and radio units.

FIG. 24 shows a communication diagram of a host 2402 communicating via a network node 2404 with a UE 2406 over a partially wireless connection in accordance with some embodiments. Example implementations, in accordance with various embodiments, of the UE (such as a UE 1912a of FIG. 19 and/or UE 2000 of FIG. 20), network node (such as network node 1910a of FIG. 19 and/or network node 2100 of FIG. 21), and host (such as host 1916 of FIG. 19 and/or host 2200 of FIG. 22) discussed in the preceding paragraphs will now be described with reference to FIG. 24.

Like host 2200, embodiments of host 2402 include hardware, such as a communication interface, processing circuitry, and memory. The host 2402 also includes software, which is stored in or accessible by the host 2402 and executable by the processing circuitry. The software includes a host application that may be operable to provide a service to a remote user, such as the UE 2406 connecting via an over-the-top (OT) connection 2450 extending between the UE 2406 and host 2402. In providing the service to the remote user, a host application may provide user data which is transmitted using the OTT connection 2450.

The network node 2404 includes hardware enabling it to communicate with the host 2402 and UE 2406. The connection 2460 may be direct or pass through a core network (like core network 1906 of FIG. 19) and/or one or more other intermediate networks, such as one or more public, private, or hosted networks. For example, an intermediate network may be a backbone network or the Internet.

The UE 2406 includes hardware and software, which is stored in or accessible by UE 2406 and executable by the UE's processing circuitry. The software includes a client application, such as a web browser or operator-specific “app” that may be operable to provide a service to a human or non-human user via UE 2406 with the support of the host 2402. In the host 2402, an executing host application may communicate with the executing client application via the OT connection 2450 terminating at the UE 2406 and host 2402. In providing the service to the user, the UE's client application may receive request data from the host's host application and provide user data in response to the request data. The OTT connection 2450 may transfer both the request data and the user data. The UE's client application may interact with the user to generate the user data that it provides to the host application through the OTT connection 2450.

The OTT connection 2450 may extend via a connection 2460 between the host 2402 and the network node 2404 and via a wireless connection 2470 between the network node 2404 and the UE 2406 to provide the connection between the host 2402 and the UE 2406. The connection 2460 and wireless connection 2470, over which the OTT connection 2450 may be provided, have been drawn abstractly to illustrate the communication between the host 2402 and the UE 2406 via the network node 2404, without explicit reference to any intermediary devices and the precise routing of messages via these devices.

As an example of transmitting data via the OTT connection 2450, in step 2408, the host 2402 provides user data, which may be performed by executing a host application. In some embodiments, the user data is associated with a particular human user interacting with the UE 2406. In other embodiments, the user data is associated with a UE 2406 that shares data with the host 2402 without explicit human interaction. In step 2410, the host 2402 initiates a transmission carrying the user data towards the UE 2406. The host 2402 may initiate the transmission responsive to a request transmitted by the UE 2406. The request may be caused by human interaction with the UE 2406 or by operation of the client application executing on the UE 2406. The transmission may pass via the network node 2404, in accordance with the teachings of the embodiments described throughout this disclosure. Accordingly, in step 2412, the network node 2404 transmits to the UE 2406 the user data that was carried in the transmission that the host 2402 initiated, in accordance with the teachings of the embodiments described throughout this disclosure. In step 2414, the UE 2406 receives the user data carried in the transmission, which may be performed by a client application executed on the UE 2406 associated with the host application executed by the host 2402.

In some examples, the UE 2406 executes a client application which provides user data to the host 2402. The user data may be provided in reaction or response to the data received from the host 2402. Accordingly, in step 2416, the UE 2406 may provide user data, which may be performed by executing the client application. In providing the user data, the client application may further consider user input received from the user via an input/output interface of the UE 2406. Regardless of the specific manner in which the user data was provided, the UE 2406 initiates, in step 2418, transmission of the user data towards the host 2402 via the network node 2404. In step 2420, in accordance with the teachings of the embodiments described throughout this disclosure, the network node 2404 receives user data from the UE 2406 and initiates transmission of the received user data towards the host 2402. In step 2422, the host 2402 receives the user data carried in the transmission initiated by the UE 2406.

In an example scenario, factory status information may be collected and analyzed by the host 2402. As another example, the host 2402 may process audio and video data which may have been retrieved from a UE for use in creating maps. As another example, the host 2402 may collect and analyze real-time data to assist in controlling vehicle congestion (e.g., controlling traffic lights). As another example, the host 2402 may store surveillance video uploaded by a UE. As another example, the host 2402 may store or control access to media content such as video, audio, VR or AR which it can broadcast, multicast or unicast to UEs. As other examples, the host 2402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OT connection 2450 between the host 2402 and UE 2406, in response to variations in the measurement results. The measurement procedure and/or the network functionality for reconfiguring the OTT connection may be implemented in software and hardware of the host 2402 and/or UE 2406. In some embodiments, sensors (not shown) may be deployed in or in association with other devices through which the OT connection 2450 passes; the sensors may participate in the measurement procedure by supplying values of the monitored quantities exemplified above, or supplying values of other physical quantities from which software may compute or estimate the monitored quantities. The reconfiguring of the OTT connection 2450 may include message format, retransmission settings, preferred routing etc.; the reconfiguring need not directly alter the operation of the network node 2404. Such procedures and functionalities may be known and practiced in the art. In certain embodiments, measurements may involve proprietary UE signaling that facilitates measurements of throughput, propagation times, latency and the like, by the host 2402. The measurements may be implemented in that software causes messages to be transmitted, in particular empty or ‘dummy’ messages, using the OTT connection 2450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

### Embodiments

1. A method performed by a radio unit, RU, node (108, 1910A, 1910B, 2100, 2304, 2308, 2404) of a base station system for performing frequency-domain beamforming for a communication between a base station and a plurality of User Equipments, UEs, (110, 1912A, 1912B, 1912C, 1912D, 2000, 2308, 2406) in a wireless communications network adapted to use a multiple antenna system for communication, the base station system further comprising a distributed unit, DU, node (106) connected to the RU node (108, 1910A, 1910B, 2100, 2304, 2308, 2404) over a fronthaul interface, the RU node (108, 1910A, 1910B, 2100, 2304, 2308, 2404) being connected to N antennas, the method comprising:
obtaining (1001) uplink signals as received at N antennas from a number of UEs (110, 1912A, 1912B, 1912C, 1912D, 2000, 2308, 2406), wirelessly connected to the RU node (108, 1910A, 1910B, 2100, 2304, 2308, 2404), the N uplink signals comprising K user-layer signals overlaid with interference signals and noise;
determining (1003) a channel estimation matrix H of wireless communication channels between a number of UEs and N antennas from reference signals as received at the N antennas from the number of UEs;
determining (1005) an estimate of an Interference plus Noise, IpN, covariance matrix Q based on the channel estimation matrix H and on other channel information different from the channel estimation matrix;
determining (1007) a first part beamforming weights, BFWs, of a beamforming matrix W₁, wherein W₁=H^{H}Q⁻¹ where H^{H} is a Hermitian transpose of H;
determining (1009) an effective channel matrix H_{eff} based on the channel estimation matrix H and the first part BFWs of the beamforming matrix W₁;
determining (1011) intermediate uplink signals based on the uplink signals and the first part BFWs of the beamforming matrix W₁, the intermediate signals having K components; and
sending (1013) the effective channel matrix H_{eff} and the intermediate uplink signals towards the DU node (106) over the fronthaul interface.
   2. The method of Embodiment 1, further comprising:
compressing the effective channel matrix H_{eff} and wherein sending the effective channel matrix H_{eff} comprises sending a compressed effective channel matrix H_{eff}.
   3. The method of any of Embodiments 1-2, wherein sending the effective channel matrix H_{eff} comprises sending a subset of components of H_{eff}.
   4. The method of Embodiment 3 wherein sending the subset of the components of H_{eff} comprises sending upper triangular components of H_{eff} or sending lower triangular components of H_{eff}.
   5. The method of any of Embodiments 1-4, wherein a frequency granularity and one or more frequency points on which the first BFW matrix W₁ is determined is a same frequency granularity or a same one or more frequency points on which a second BFW matrix W₂ is determined at the DU node (106).
   6. The method of Embodiment 5, further comprising exchanging (1101) information about the frequency granularity or frequency point(s) on which the first part BFW matrix W₁ is determined with the DU node (106).
   7. The method of Embodiment 6 wherein exchanging information about the frequency granularity or frequency point(s) on which the first part BFW matrix W₁ is determined with the DU comprises:
providing RU capability to the DU node (106) regarding at least one of:
   one or more possible frequency granularities or frequency points on which the channel estimates H and/or the estimated Interference plus Noise, IpN, covariance matrix Q can be obtained; and
   one or more possible frequency granularities or frequency points on which the first part BFW matrix W₁ can be calculated and applied.
      8. The method of Embodiment 6, further comprising:
receiving (1201) an indication from the DU node (106) about which frequency granularity or frequency points should be used for determining and applying the first part BFW matrix W₁; and
using the one or more frequency granularities or frequency points indicated by the DU node (106) for determining and applying the first part BFW matrix W₁.
   9. The method of Embodiment 5, further comprising dynamically reconfiguring the frequency granularity.
   10. A method performed by a distributed unit, DU, node (106, 1910A, 1910B, 2100, 2304, 2308, 2404) for assisting a radio unit, RU, node (108, 1910A, 1910B, 2100, 2304, 2308, 2404) to perform beamforming for a communication between a base station and a user equipment, UE, (110, 1912A, 1912B, 1912C, 1912D, 2000, 2308, 2406) in a wireless communications network using a multiple antenna system for communication, wherein the DU node 106 and the RU node 108 are associated with the base station (102), the method comprising:
receiving (1301), from the RU node (108, 1910A, 1910B, 2100, 2304, 2308, 2404) over a fronthaul interface, intermediate uplink signals;
obtaining (1303) an effective channel matrix H_{eff};
determining (1305) a second part Beamforming Weights, BFWs, of a beamforming matrix W₂=(H_{eff}+σ²I)⁻¹ based on the effective channel matrix H_{eff} and a regularization factor σ²; and
determining (1307) output signals, which are estimations of K user-layer signals, by multiplying the intermediate uplink signals sent by the RU node (108, 1910A, 1910B, 2100, 2304, 2308, 2404) with the second part BFWs of the beamforming matrix W₂.
   11. The method of Embodiment 10, wherein obtaining the effective channel matrix H_{eff} comprise receiving the effective channel matrix H_{eff} from the RU node (108, 1910A, 1910B, 2100, 2304, 2308, 2404).
   12. The method of Embodiment 10, wherein obtaining the effective channel matrix H_{eff} comprises:
receiving (1401) a compressed effective channel matrix H_{eff} from the RU node (108, 1910A, 1910B, 2100, 2304, 2308, 2404); and
de-compressing (1403) the compressed effective channel matrix H_{eff} to obtain the effective channel matrix H_{eff}.
   13. The method of Embodiment 12, wherein receiving the compressed effective channel matrix H_{eff} from the RU node (108, 1910A, 1910B, 2100, 2304, 2308, 2404) comprises receiving a subset of the effective channel matrix H_{eff}.
   14. The method of Embodiment 13 wherein receiving the subset of the effective channel matrix H_{eff} comprises receiving (1501) upper triangular components of H_{eff} or lower triangular components of H_{eff} and de-compressing the compressed effective channel matrix H_{eff} comprises reconstructing (1503) H_{eff} by obtaining a remainder of the components by performing a complex conjugate on the received upper triangular components of H_{eff} or lower triangular components of H_{eff}.
   15. The method of Embodiment 10, wherein obtaining the effective channel matrix H_{eff} comprises:
receiving (1601) a plurality of effective channel matrices from a plurality of RU nodes (108, 1910A, 1910B, 2100, 2304, 2308, 2404) and
summing (1603) the plurality of effective channel matrices to form the effective channel matrix H_{eff}.
   16. The method of Embodiment 10, wherein obtaining an effective channel matrix H_{eff} comprises estimating the effective channel matrix H_{eff}.
   17. The method of Embodiment 16, wherein estimating the effective channel matrix H_{eff} comprises estimating the effective channel matrix H_{eff} using reference signals as received from at least part of the intermediate uplink signals.
   18. The method of any of Embodiments 16-17, wherein estimating the effective channel matrix H_{eff} comprises:
for each RU node (108, 1910A, 1910B, 2100, 2304, 2308, 2404) of a plurality of RU nodes (108, 1910A, 1910B, 2100, 2304, 2308, 2404) connected to the DU node (106, 1910A, 1910B, 2100, 2304, 2308, 2404), estimating an effective channel matrix H_{eff} for the RU node (108, 1910A, 1910B, 2100, 2304, 2308, 2404) to form an estimated effective channel matrix H_{eff} for the RU node (108, 1910A, 1910B, 2100, 2304, 2308, 2404);
for the plurality of RU nodes (108, 1910A, 1910B, 2100, 2304, 2308, 2404), summing each estimated effective channel matrix H_{eff} to form a summed estimated effective channel matrix; and
estimating the effective channel matrix H_{eff} by setting the effective channel matrix H_{eff} to the summed estimated effective channel matrix.
   19. The method of any of Embodiments 10-18, wherein the regularization factor σ² is a non-negative real value.
   20. The method of any of Embodiments 10-19, wherein the regularization factor σ² is based on the effective channel matrix H_{eff}.
   21. The method of any of Embodiments 10-20, wherein a frequency granularity and one or more frequency points on which the second BFW matrix W₂ is determined is a same frequency granularity and one or more frequency points on which a first BFW matrix W₁ is determined at the RU node (108, 1910A, 1910B, 2100, 2304, 2308, 2404).
   22. The method of Embodiment 21, further comprising exchanging (1701) information about the frequency granularity and frequency point(s) on which the second part BFW matrix W₂ is determined with the RU node (108, 1910A, 1910B, 2100, 2304, 2308, 2404).
   23. The method of Embodiment 22 wherein exchanging information about the frequency granularity and frequency point(s) on which the second part BFW matrix W₂ is determined with the RU node (108, 1910A, 1910B, 2100, 2304, 2308, 2404) comprises:
obtaining RU capability regarding frequency granularities the RU node (108, 1910A, 1910B, 2100, 2304, 2308, 2404) supports, comprising at least one of:
   one or more possible frequency granularities and frequency points on which the channel estimates H and/or an estimated IpN covariance matrix Q can be obtained; and
   one or more possible frequency granularities and frequency points on which the first part BFW matrix W₁ can be calculated and applied.
      24. The method of Embodiment 23, further comprising: determining (1803) which frequency granularity and frequency points to use for determining the second part BFW matrix W₂.
      25. The method of Embodiment 24 wherein determining the frequency points to use comprises obtaining the frequency points from at least one of a table or as a function of parameters, the parameters comprising one or more of subcarrier spacing and occupied bandwidth.
      26. The method of any of Embodiments 24-25, further comprising:
sending (1805) an indication to the RU node (108, 1910A, 1910B, 2100, 2304, 2308, 2404) about which frequency granularity and frequency points should be used for determining and applying the first part BFW matrix W₁.
   27. The method of Embodiment 21, further comprising dynamically reconfiguring the frequency granularity by sending an indication of the frequency granularity and frequency points to use to the RU node (108, 1910A, 1910B, 2100, 2304, 2308, 2404).
   28. A radio unit node (108, 1910A, 1910B, 2100, 2304, 2308, 2404) adapted to perform according to any of Embodiments 1-9.
   29. A radio unit node (108, 1910A, 1910B, 2100, 2304, 2308, 2404) comprising:
processing circuitry (303, 2102); and
memory (305, 2104) coupled with the processing circuitry, wherein the memory includes instructions that when executed by the processing circuitry causes the communication device to perform operations according to any of Embodiments 1-9.
   30. A computer program comprising program code to be executed by processing circuitry (303, 2102) of a radio unit, RU, node (108, 1910A, 1910B, 2100, 2304, 2308, 2404), whereby execution of the program code causes the RU node (108, 1910A, 1910B, 2100, 2304, 2308, 2404) to perform operations according to any of Embodiments 1-9.
   31. A computer program product comprising a non-transitory storage medium including program code to be executed by processing circuitry (803, 2102) of a radio unit, RU, node (108, 1910A, 1910B, 2100, 2304, 2308, 2404), whereby execution of the program code causes the RU node (108, 1910A, 1910B, 2100, 2304, 2308, 2404) to perform operations according to any of Embodiments 1-9.
   32. A distributed unit, DU, node (106, 1910A, 1910B, 2100, 2304, 2308, 2404) adapted to perform according to any of Embodiments 10-27.
   33. A distributed unit, DU, node (106, 1910A, 1910B, 2100, 2304, 2308, 2404) comprising:
processing circuitry (403, 2102); and
memory (405, 2104) coupled with the processing circuitry, wherein the memory includes instructions that when executed by the processing circuitry causes the DU node to perform operations according to any of Embodiments 10-27.
   34. A computer program comprising program code to be executed by processing circuitry (403, 2102) of a distributed unit, DU, node (106, 1910A, 1910B, 2100, 2304, 2308, 2404), whereby execution of the program code causes the DU node (106, 1910A, 1910B, 2100, 2304, 2308, 2404) to perform operations according to any of Embodiments 10-27.
   35. A computer program product comprising a non-transitory storage medium including program code to be executed by processing circuitry (403, 2102) of a distributed unit, DU, node (106, 1910A, 1910B, 2100, 2304, 2308, 2404), whereby execution of the program code causes the DU node (106, 1910A, 1910B, 2100, 2304, 2308, 2404) to perform operations according to any of Embodiments 10-27.

Explanations are provided below for various abbreviations/acronyms used in the present disclosure.
Abbreviation Explanation
BBU Baseband unit
BFW Beamforming weight
CPRI Common Public Radio Interface
DL Downlink
DMRS De-modulation reference signal
LLS Lower-layer split
MIMO Multiple-input multiple output
PHY Physical Layer
RU Radio unit
SRS Sounding reference signal
TDD Time-division duplex
UE User equipment
UL Uplink

1. A method performed by a radio unit, RU, node of a base station system for performing frequency-domain beamforming for a communication between a base station and a plurality of User Equipments, UEs, in a wireless communications network adapted to use a multiple antenna system for communication, the base station system further comprising a distributed unit, DU, node connected to the RU node over a fronthaul interface, the RU node being connected to N antennas, the method comprising:
obtaining uplink signals as received at N antennas from a number of UEs, wirelessly connected to the RU node, the N uplink signals comprising K user-layer signals overlaid with interference signals and noise;
determining a channel estimation matrix H of wireless communication channels between a number of UEs and N antennas from reference signals as received at the N antennas from the number of UEs;
determining an estimate of an Interference plus Noise, IpN, covariance matrix Q based on the channel estimation matrix H and on other channel information different from the channel estimation matrix;
determining a first part beamforming weights, BFWs, of a beamforming matrix W₁, wherein W₁=H^{H}Q⁻¹ where H^{H} is a Hermitian transpose of H;
determining an effective channel matrix H_{eff} based on the channel estimation matrix H and the first part BFWs of the beamforming matrix W₁;
determining intermediate uplink signals based on the uplink signals and the first part BFWs of the beamforming matrix W₁, the intermediate signals having K components; and
sending the effective channel matrix H_{eff} and the intermediate uplink signals towards the DU node over the fronthaul interface.

2. The method of claim 1, further comprising:
compressing the effective channel matrix H_{eff} and wherein sending the effective channel matrix H_{eff} comprises sending a compressed effective channel matrix H_{eff}.

3. The method of claim 1, wherein sending the effective channel matrix H_{eff} comprises sending a subset of components of H_{eff}.

4. The method of claim 3 wherein sending the subset of the components of H_{eff} comprises sending upper triangular components of H_{eff} or sending lower triangular components of H_{eff}.

5. The method of claim 1, wherein a frequency granularity and one or more frequency points on which the first BFW matrix W₁ is determined is a same frequency granularity or a same one or more frequency points on which a second BFW matrix W₂ is determined at the DU node.

6. The method of claim 5, further comprising exchanging information about the frequency granularity or frequency point(s) on which the first part BFW matrix W₁ is determined with the DU node.

7. The method of claim 6 wherein exchanging information about the frequency granularity or frequency point(s) on which the first part BFW matrix W₁ is determined with the DU comprises:
providing RU capability to the DU node regarding at least one of:
one or more possible frequency granularities or frequency points on which the channel estimates H and/or the estimated Interference plus Noise, IpN, covariance matrix Q can be obtained; and
one or more possible frequency granularities or frequency points on which the first part BFW matrix W₁ can be calculated and applied.

8. The method of claim 6, further comprising:
receiving an indication from the DU node about which frequency granularity or frequency points should be used for determining and applying the first part BFW matrix W₁; and
using the one or more frequency granularities or frequency points indicated by the DU node for determining and applying the first part BFW matrix W₁.

9. The method of claim 5, further comprising dynamically reconfiguring the frequency granularity.

10. A method performed by a distributed unit, DU, node for assisting a radio unit, RU, node to perform beamforming for a communication between a base station and a user equipment, UE, in a wireless communications network using a multiple antenna system for communication, wherein the DU node and the RU node are associated with the base station, the method comprising:
receiving, from the RU node over a fronthaul interface, intermediate uplink signals;
obtaining an effective channel matrix H_{eff};
determining a second part Beamforming Weights, BFWs, of a beamforming matrix W₂=(H_{eff}+σ²I)⁻¹ based on the effective channel matrix H_{eff} and a regularization factor σ²; and
determining output signals, which are estimations of K user-layer signals, by multiplying the intermediate uplink signals sent by the RU node with the second part BFWs of the beamforming matrix W₂.

11. The method of claim 10, wherein obtaining the effective channel matrix H_{eff} comprise receiving the effective channel matrix H_{eff} from the RU node.

12. The method of claim 10, wherein obtaining the effective channel matrix H_{eff} comprises:
receiving a compressed effective channel matrix H_{eff} from the RU node; and
de-compressing the compressed effective channel matrix H_{eff} to obtain the effective channel matrix H_{eff}.

13. The method of claim 12, wherein receiving the compressed effective channel matrix H_{eff} from the RU node comprises receiving a subset of the effective channel matrix H_{eff}.

14. The method of claim 13 wherein receiving the subset of the effective channel matrix H_{eff} comprises receiving upper triangular components of H_{eff} or lower triangular components of H_{eff} and de-compressing the compressed effective channel matrix H_{eff} comprises reconstructing H_{eff} by obtaining a remainder of the components by performing a Hermitian transpose on the received upper triangular components of H_{eff} or lower triangular components of H_{eff}.

15. The method of claim 10, wherein obtaining the effective channel matrix H_{eff} comprises:
receiving a plurality of effective channel matrices from a plurality of RU nodes and
summing the plurality of effective channel matrices to form the effective channel matrix H_{eff}.

16. The method of claim 10, wherein obtaining an effective channel matrix H_{eff} comprises estimating the effective channel matrix H_{eff}.

17. The method of claim 16, wherein estimating the effective channel matrix H_{eff} comprises estimating the effective channel matrix H_{eff} using reference signals as received from at least part of the intermediate uplink signals.

18. The method of claim 16, wherein estimating the effective channel matrix H_{eff} comprises:
for each RU node of a plurality of RU nodes connected to the DU node, estimating an effective channel matrix H_{eff} for the RU node to form an estimated effective channel matrix H_{eff} for the RU node;
for the plurality of RU nodes, summing each estimated effective channel matrix H_{eff} to form a summed estimated effective channel matrix; and
estimating the effective channel matrix H_{eff} by setting the effective channel matrix H_{eff} to the summed estimated effective channel matrix.

19. The method of claim 10, wherein the regularization factor σ² is a non-negative real value.

20. The method of claim 10, wherein the regularization factor σ² is based on the effective channel matrix H_{eff}.

21-35. (canceled)
